(19) United States
(12) Patent Application Publication
(10) Pub. No.: US 2021/0287559 A1
(43) Pub. Date: Sep. 16, 2021

(54) DEVICE, SYSTEM, AND METHOD FOR CONTROLLING UNMANNED AERIAL VEHICLE

(71) Applicant: LG ELECTRONICS INC., Seoul (KR)

(72) Inventors: Yuseung JEONG, Seoul (KR); Hyunjai SHIM, Seoul (KR); Jeongkyo SEO, Seoul (KR)

(73) Assignee: LG ELECTRONICS INC.

(21) Appl. No.: 16/932,224

(22) Filed: Jul. 17, 2020

(30) Foreign Application Priority Data
Mar. 11, 2020 (KR) 10-2020-0029998

(51) Int. Cl. G08G 5/00; G05D 1/10; B64C 39/02; G06N 20/00

(52) U.S. Cl. CPC G08G 5/0039; G08G 5/0013; G08G 5/0086; G08G 5/0069; B64C 2201/146; B64C 39/024; G06N 20/00; B64C 2201/123; G05D 1/106

(57) ABSTRACT

Disclosed is a device, system, and method for controlling a UAV. According to the disclosure, a device for controlling a UAV may be related to artificial intelligence (AI) modules, robots, augmented reality (AR) devices, virtual reality (VR) devices, and 5G service-related devices.

### CROSS-REFERENCE TO RELATED APPLICATION

This application claims priority under 35 U.S.C. § 119 to Korean Application No. 10-2020-0029998 filed on Mar. 11, 2020, whose entire disclosure is hereby incorporated by reference.

### BACKGROUND

### 1. Field

The disclosure relates to a device, system, and method for saving fuel consumption and flight time by controlling an unmanned aerial vehicle.

### 2. Background

Unmanned aerial vehicles (UAVs) include aircrafts without a human pilot on board, which may be remotely controlled on the ground. Drones recently gaining popularity are a type of UAVs. Drones may be automatically and remotely controlled via a controller on the ground without a pilot on board.

Early forms of UAVs have mostly been used for military purposes, but with the technology growth, UAVs are recently being adopted for other various civilian or commercial applications, including filmmaking, environment and wildfire surveillance, border/coast/road surveillance, disaster support communication relaying, and remote exploration.

Meanwhile, as UAV-related technology advances, UAVs come with remote detectors, satellite controllers, or other various state-of-the-art devices. As an example, a UAV is equipped with an infrared (IR) camera, GPS, and a heat or motion sensor to enable real-time recognition of geographical features, objects, or human beings while in flight.

Conventional UAVs typically fly along the route configured in flight planning. If the preset corridor includes way points where a significant variation in azimuth (flight direction) occurs, the UAV needs to turn with a reduced radius of turn at the way points. In this case, the UAV quickly decelerates immediate before arriving at a way point and, after arrival at the way point, turns its head to adjust the azimuth and then accelerates and flies to the next way point. Thus, if the UAV flies along the corridor with many way points, its battery and fuel consumption significantly increases, and the overall flight time shortens, causing inconvenience in operating and using the UAV.

### BRIEF DESCRIPTION OF THE DRAWINGS

The embodiments will be described in detail with reference to the following drawings in which like reference numerals refer to like elements wherein:

FIG. 1 shows a perspective view of an unmanned aerial vehicle according to an embodiment of the disclosure.

FIG. 2 is a block diagram showing a control relation between major elements of the unmanned aerial vehicle of FIG. 1.

FIG. 3 is a block diagram showing a control relation between major elements of an unmanned aerial vehicle according to an embodiment of the disclosure.

FIG. 4 illustrates a block diagram of a wireless communication system to which methods proposed in this specification may be applied.

FIG. 5 is a diagram showing an example of a signal transmission/reception method in a wireless communication system.

FIG. 6 shows an example of a basic operation of the robot and a 5G network in a 5G communication system.

FIG. 7 illustrates an example of a basic operation between robots using 5G communication.

FIG. 8 is a diagram showing an example of the concept diagram of a 3GPP system including a UAS.

FIG. 9 shows examples of a C2 communication model for a UAV.

FIG. 10 is a flowchart showing an example of a measurement execution method to which the disclosure may be applied.

FIG. 11 is a block diagram illustrating an AI device according to an embodiment of the disclosure.

FIG. 12 is a block diagram illustrating main components of a device and system for controlling a UAV according to an embodiment of the disclosure.

FIG. 13 is a view illustrating various example methods in which a UAV flies via way points according to an embodiment of the disclosure.

FIG. 14 is a flowchart illustrating a method of controlling a UAV by a device or system according to an embodiment of the disclosure.

FIG. 15 is a view illustrating an example of outputting a corridor configured by a device or system, in the form of a web screen according to an embodiment of the disclosure.

FIG. 16 is a view illustrating an example of outputting a corridor configured as fly-over navigation by a device or system, in the form of a web screen according to an embodiment of the disclosure.

FIG. 17 is a view illustrating an example of outputting a corridor configured as fly-by navigation by a device or system, in the form of a web screen according to an embodiment of the disclosure.

FIG. 18 is a flowchart illustrating a method of configuring a pattern corridor of a UAV by a device or system according to an embodiment of the disclosure.

FIG. 19 is a view illustrating an example of outputting a pattern corridor as a web screen according to the flowchart of FIG. 18.

FIG. 20 is a view illustrating an example of outputting a newly configured pattern corridor, other than an existing pattern corridor, by a device or system according to an embodiment of the disclosure.

FIG. 21 is a flowchart illustrating a method of configuring a corridor width for a UAV by a device or system according to an embodiment of the disclosure.

FIG. 22 is a view illustrating an example of avoiding a collision between one UAV and another based on a corridor width configured according to the flowchart of FIG. 21.

FIG. 23 is a flowchart illustrating a method of controlling a UAV according to another embodiment of the disclosure.

FIG. 24 is a flowchart illustrating a method of configuring an additional way point by a device or system according to the disclosure.

### DETAILED DESCRIPTION

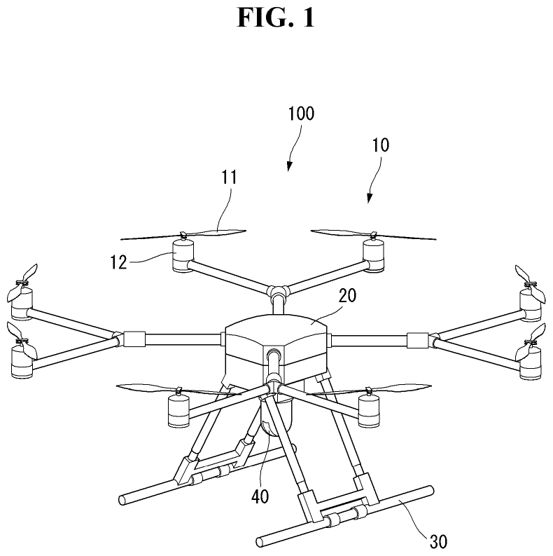

FIG. 1 shows a perspective view of an unmanned aerial robot according to an embodiment of the disclosure. First, the unmanned aerial vehicle (or an unmanned aerial robot) 100 is manually manipulated by an administrator on the ground, or it flies in an unmanned manner while it is automatically piloted by a configured flight program. The unmanned aerial vehicle 100, as in FIG. 1, is configured with a main body 20, the horizontal and vertical movement propulsion device 10, and landing legs 130.

The main body 20 is a body portion on which a module, such as a task unit 40, is mounted. The horizontal and vertical movement propulsion device 10 is configured with one or more propellers 11 positioned vertically to the main body 20. The horizontal and vertical movement propulsion device 10 according to an embodiment of the disclosure includes a plurality of propellers 11 and motors 12, which are spaced apart. In this case, the horizontal and vertical movement propulsion device 10 may have an air jet propeller structure not the propeller 11.

A plurality of propeller supports is radially formed in the main body 20. The motor 12 may be mounted on each of the propeller supports. The propeller 11 is mounted on each motor 12.

The plurality of propellers 11 may be disposed symmetrically with respect to the main body 20. Furthermore, the rotation direction of the motor 12 may be determined so that the clockwise and counterclockwise rotation directions of the plurality of propellers 11 are combined. The rotation direction of one pair of the propellers 11 symmetrical with respect to the main body 20 may be configured identically (e.g., clockwise). Furthermore, the other pair of the propellers 11 may have a rotation direction opposite (e.g., counterclockwise) that of the one pair of the propellers 11.

The landing legs 30 are disposed with being spaced apart at the bottom of the main body 20. Furthermore, a buffering support member (not shown) for minimizing an impact attributable to a collision with the ground when the unmanned aerial vehicle 100 makes a landing may be mounted on the bottom of the landing leg 30. The unmanned aerial vehicle 100 may have various aerial vehicle structures different from that described above.

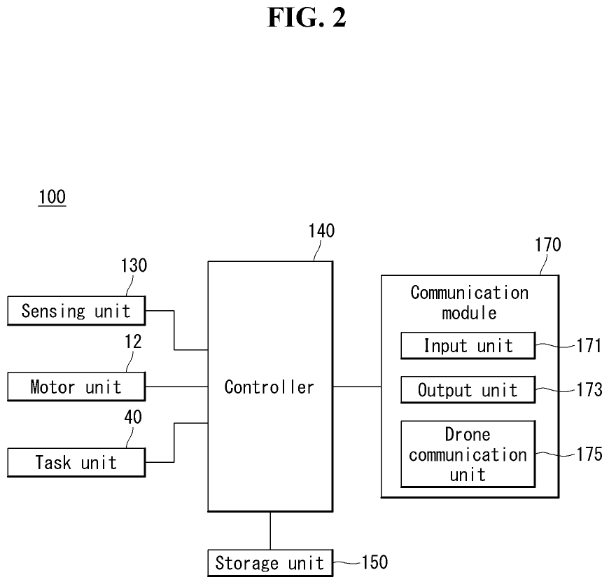

FIG. 2 is a block diagram showing a control relation between major elements of the unmanned aerial vehicle of FIG. 1. Referring to FIG. 2, the unmanned aerial vehicle 100 measures its own flight state using a variety of types of sensors in order to fly stably. The unmanned aerial vehicle 100 may include a sensing unit 130 including at least one sensor.

The flight state of the unmanned aerial vehicle 100 is defined as rotational states and translational states. The rotational states mean “yaw”, “pitch”, and “roll.” The translational states mean longitude, latitude, altitude, and velocity. In this case, “roll”, “pitch”, and “yaw” are called Euler angle, and indicate that the x, y, z three axes of an aircraft body frame coordinate have been rotated with respect to a given specific coordinate, for example, three axes of NED coordinates N, E, D. If the front of an aircraft is rotated left and right on the basis of the z axis of a body frame coordinate, the x axis of the body frame coordinate has an angle difference with the N axis of the NED coordinate, and this angle is called “yaw” (ψ). If the front of an aircraft is rotated up and down on the basis of the y axis toward the right, the z axis of the body frame coordinate has an angle difference with the D axis of the NED coordinates, and this angle is called a “pitch” (θ). If the body frame of an aircraft is inclined left and right on the basis of the x axis toward the front, the y axis of the body frame coordinate has an angle to the E axis of the NED coordinates, and this angle is called “roll” (ϕ).

The unmanned aerial vehicle 100 uses 3-axis gyroscopes, 3-axis accelerometers, and 3-axis magnetometers in order to measure the rotational states, and uses a GPS sensor and a barometric pressure sensor in order to measure the translational states.

The sensing unit 130 of the disclosure includes at least one of the gyroscopes, the accelerometers, the GPS sensor, the image sensor or the barometric pressure sensor. In this case, the gyroscopes and the accelerometers measure the states in which the body frame coordinates of the unmanned aerial vehicle 100 have been rotated and accelerated with respect to earth centered inertial coordinate. The gyroscopes and the accelerometers may be fabricated as a single chip called an inertial measurement unit (IMU) using a micro-electro-mechanical systems (MEMS) semiconductor process technology. Furthermore, the IMU chip may include a microcontroller for converting measurement values based on the earth centered inertial coordinates, measured by the gyroscopes and the accelerometers, into local coordinates, for example, north-east-down (NED) coordinates used by GPSs.

The gyroscopes measure angular velocity at which the body frame coordinate x, y, z three axes of the unmanned aerial vehicle 100 rotate with respect to the earth centered inertial coordinates, calculate values (Wx.gyro, Wy.gyro, Wz.gyro) converted into fixed coordinates, and convert the values into Euler angles (ϕgyro, θgyro, ψgyro) using a linear differential equation.

The accelerometers measure acceleration for the earth centered inertial coordinates of the body frame coordinate x, y, z three axes of the unmanned aerial vehicle 100, calculate values (fx,acc, fy,acc, fz,acc) converted into fixed coordinates, and convert the values into “roll (ϕacc)” and “pitch (θacc).” The values are used to remove a bias error included in “roll (ϕgyro)” and “pitch (θgyro)” using measurement values of the gyroscopes. The magnetometers measure the direction of magnetic north points of the body frame coordinate x, y, z three axes of the unmanned aerial vehicle 100, and calculate a “yaw” value for the NED coordinates of body frame coordinates using the value.

The GPS sensor calculates the translational states of the unmanned aerial vehicle 100 on the NED coordinates, that is, a latitude (Pn.GPS), a longitude (Pe.GPS), an altitude (hMSL.GPS), velocity (Vn.GPS) on the latitude, velocity (Ve.GPS) on longitude, and velocity (Vd.GPS) on the altitude, using signals received from GPS satellites. In this case, the subscript MSL means a mean sea level (MSL).

The barometric pressure sensor may measure the altitude (hALP.baro) of the unmanned aerial vehicle 100. In this case, the subscript ALP means an air-level pressor. The barometric pressure sensor calculates a current altitude from a take-off point by comparing an air-level pressor when the unmanned aerial vehicle 100 takes off with an air-level pressor at a current flight altitude.

The camera sensor may include an image sensor (e.g., CMOS image sensor), including at least one optical lens and multiple photodiodes (e.g., pixels) on which an image is focused by light passing through the optical lens, and a digital signal processor (DSP) configuring an image based on signals output by the photodiodes. The DSP may generate a moving image including frames configured with a still image, in addition to a still image.

The unmanned aerial vehicle 100 includes a communication module 170 for inputting or receiving information or outputting or transmitting information. The communication module 170 may include a drone communication unit 175 for transmitting/receiving information to/from a different external device. The communication module 170 may include an input unit 171 for inputting information. The communication module 170 may include an output unit 173 for outputting information.

The output unit 173 may be omitted from the unmanned aerial vehicle 100, and may be formed in a terminal 300. For example, the unmanned aerial vehicle 100 may directly receive information from the input unit 171. For another example, the unmanned aerial vehicle 100 may receive information, input to a separate terminal 300 or server 200, through the drone communication unit 175.

For example, the unmanned aerial vehicle 100 may directly output information to the output unit 173. For another example, the unmanned aerial vehicle 100 may transmit information to a separate terminal 300 through the drone communication unit 175 so that the terminal 300 outputs the information.

The drone communication unit 175 may be provided to communicate with an external server 200, an external terminal 300, etc. The drone communication unit 175 may receive information input from the terminal 300, such as a smartphone or a computer. The drone communication unit 175 may transmit information to be transmitted to the terminal 300. The terminal 300 may output information received from the drone communication unit 175.

The drone communication unit 175 may receive various command signals from the terminal 300 or/and the server 200. The drone communication unit 175 may receive area information for driving, a driving route, or a driving command from the terminal 300 or/and the server 200. In this case, the area information may include flight restriction area (A) information and approach restriction distance information.

The input unit 171 may receive On/Off or various commands. The input unit 171 may receive area information. The input unit 171 may receive object information. The input unit 171 may include various buttons or a touch pad or a microphone.

The output unit 173 may notify a user of various pieces of information. The output unit 173 may include a speaker and/or a display. The output unit 173 may output information on a discovery detected while driving. The output unit 173 may output identification information of a discovery. The output unit 173 may output location information of a discovery.

The unmanned aerial vehicle 100 includes a processor 140 for processing and determining various pieces of information, such as mapping and/or a current location. The processor 140 may control an overall operation of the unmanned aerial vehicle 100 through control of various elements that configure the unmanned aerial vehicle 100.

The processor 140 may receive information from the communication module 170 and process the information. The processor 140 may receive information from the input unit 171, and may process the information. The processor 140 may receive information from the drone communication unit 175, and may process the information.

The processor 140 may receive sensing information from the sensing unit 130, and may process the sensing information. The processor 140 may control the driving of the motor 12. The processor 140 may control the operation of the task unit 40.

The unmanned aerial vehicle 100 includes a storage unit 150 for storing various data. The storage unit 150 records various pieces of information necessary for control of the unmanned aerial vehicle 100, and may include a volatile or non-volatile recording medium.

A map for a driving area may be stored in the storage unit 150. The map may have been input by the external terminal 300 capable of exchanging information with the unmanned aerial vehicle 100 through the drone communication unit 175, or may have been autonomously learnt and generated by the unmanned aerial vehicle 100. In the former case, the external terminal 300 may include a remote controller, a PDA, a laptop, a smartphone or a tablet on which an application for a map configuration has been mounted, for example.

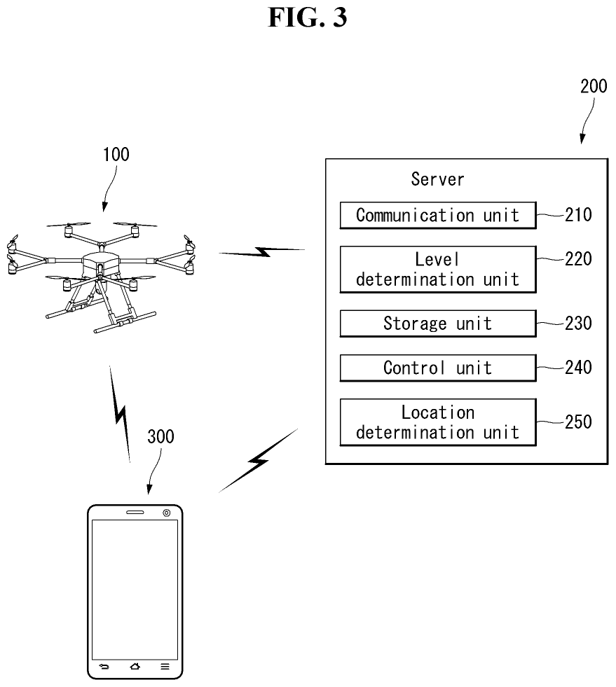

FIG. 3 is a block diagram showing a control relation between major elements of an aerial control system according to an embodiment of the disclosure. Referring to FIG. 3, the aerial control system according to an embodiment of the disclosure may include the unmanned aerial vehicle 100 and the server 200, or may include the unmanned aerial vehicle 100, the terminal 300, and the server 200. The unmanned aerial vehicle 100, the terminal 300, and the server 200 are interconnected using a wireless communication method.

Global system for mobile communication (GSM), code division multi access (CDMA), code division multi access 2000 (CDMA2000), enhanced voice-data optimized or enhanced voice-data only (EV-DO), wideband CDMA (WCDMA), high speed downlink packet access (HSDPA), high speed uplink packet access (HSUPA), long term evolution (LTE), long term evolution-advanced (LTE-A), etc. may be used as the wireless communication method.

A wireless Internet technology may be used as the wireless communication method. The wireless Internet technology includes a wireless LAN (WLAN), wireless-fidelity (Wi-Fi), wireless fidelity (Wi-Fi) direct, digital living network alliance (DLNA), wireless broadband (WiBro), world interoperability for microwave access (WiMAX), high speed downlink packet access (HSDPA), high speed uplink packet access (HSUPA), long term evolution (LTE), long term evolution-advanced (LTE-A), and 5G, for example. In particular, a faster response is possible by transmitting/receiving data using a 5G communication network.

FIG. 3 is a block diagram illustrating a control relation between main components of a system for controlling a UAV according to an embodiment of the disclosure. Referring to FIG. 3, according to an embodiment of the disclosure, a system for controlling an unmanned aerial vehicle (UAV) may include a UAV 100 and a server 200 or may include a UAV 100, a terminal 300, and a server 200. The UAV 100, the terminal 300, and the server 200 are connected with each other via a wireless communication method.

The wireless communication method may use, e.g., global system for mobile communication (GSM), code division multiple access (CDMA), CDMA2000, enhanced voice-data optimized or enhanced voice-data only (EV-DO), wideband CDMA (WCDMA), high speed downlink packet access (HSDPA), high speed uplink packet access (HSUPA), long term evolution (LTE), or LTE-advanced (LTE-A).

The wireless communication method may use wireless internet technology. The wireless Internet technology includes, e.g., WLAN (Wireless LAN), Wi-Fi (Wireless-Fidelity), Wi-Fi (Wireless Fidelity) Direct, DLNA (Digital Living Network Alliance), WiBro (Wireless Broadband), WiMAX (World Interoperability for Microwave Access), HSDPA (High Speed Downlink Packet Access), HSUPA (High Speed Uplink Packet Access), LTE (Long Term Evolution), LTE-A (Long Term Evolution-Advanced), or 5G. In particular, responding may be performed more quickly by transmitting and receiving data using a 5G communication network.

As shown in FIG. 3, the server 200 may include a first communication unit 210, a level determination unit 220, a storage unit 230, a control unit 240, and a location determination unit 250. The server communication unit 210 performs data communication that transmits and receives information to/from a drone communication unit 175 of the UAV 100, i.e., a drone 100.

The level determination unit 220 gathers and determines the altitude, orientation, and priority duty information for the UAV 100. The server storage unit 230 records various pieces information necessary to control the UAV 100 and various pieces of information necessary to control the terminal 300 and to communicate with the terminal 300 and may include a volatile or non-volatile recording medium.

The control unit 240 generates direct control signals for the drone 100. The location determination unit 250 may gather the location, speed, and corridor of the drone 100 and topography information for the area the corridor passes through and may grasp the location of the drone 100.

In this specification, a base station has a meaning as a terminal node of a network that directly performs communication with a terminal. In this specification, a specific operation illustrated as being performed by a base station may be performed by an upper node of the base station in some cases. That is, it is evident that in a network configured with a plurality of network nodes including a base station, various operations performed for communication with a terminal may be performed by the base station or different network nodes other than the base station. A “base station (BS)” may be substituted with a term, such as a fixed station, a Node B, an evolved-NodeB (eNB), a base transceiver system (BTS), an access point (AP), or a next generation NodeB (gNB). Furthermore, a “terminal” may be fixed or may have mobility, and may be substituted with a term, such as a user equipment (UE), a mobile station (MS), a user terminal (UT), a mobile subscriber station (MSS), a subscriber station (SS), an advanced mobile station (AMS), a wireless terminal (WT), a machine-type communication (MTC) device, a machine-to-machine (M2M) device, or a device-to-device (D2D) device.

Hereinafter, downlink (DL) means communication from a base station to a terminal. Uplink (UL) means communication from a terminal to a base station. In the downlink, a transmitter may be part of a base station, and a receiver may be part of a terminal. In the uplink, a transmitter may be part of a terminal, and a receiver may be part of a base station.

Specific terms used in the following description have been provided to help understanding of the disclosure. The use of such a specific term may be changed into another form without departing from the technical spirit of the disclosure.

Embodiments of the disclosure may be supported by standard documents disclosed in at least one of IEEE 802, 3GPP and 3GPP2, that is, radio access systems. That is, steps or portions not described in order not to clearly disclose the technical spirit of the disclosure in the embodiments of the disclosure may be supported by the documents. Furthermore, all terms disclosed in this document may be described by the standard documents. In order to clarity the description, 3GPP 5G is chiefly described, but the technical characteristic of the disclosure is not limited thereto.

UE and 5G Network Block Diagram Example

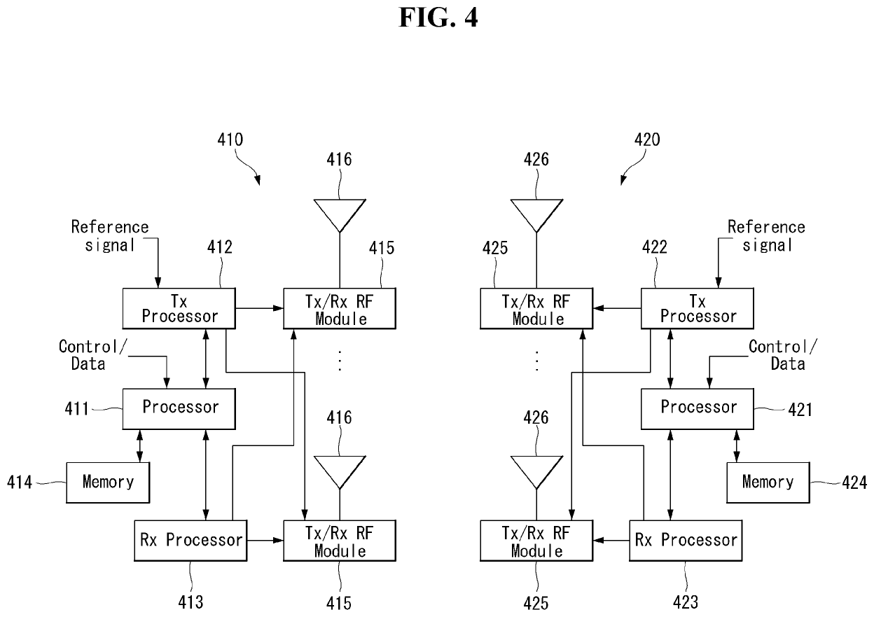

FIG. 4 illustrates a block diagram of a wireless communication system to which methods proposed in this specification may be applied. Referring to FIG. 4, a drone is defined as a first communication device (410 of FIG. 4). A processor 411 may perform a detailed operation of the drone. The drone may be represented as an unmanned aerial vehicle or an unmanned aerial robot.

A 5G network communicating with a drone may be defined as a second communication device (420 of FIG. 4). A processor 421 may perform a detailed operation of the drone. In this case, the 5G network may include another drone communicating with the drone.

A 5G network maybe represented as a first communication device, and a drone may be represented as a second communication device. For example, the first communication device or the second communication device may be a base station, a network node, a transmission terminal, a reception terminal, a wireless apparatus, a wireless communication device or a drone.

For example, a terminal or a user equipment (UE) may include a drone, an unmanned aerial vehicle (UAV), a mobile phone, a smartphone, a laptop computer, a terminal for digital broadcasting, personal digital assistants (PDA), a portable multimedia player (PMP), a navigator, a slate PC, a tablet PC, an ultrabook, a wearable device (e.g., a watch type terminal (smartwatch), a glass type terminal (smart glass), and a head mounted display (HMD). For example, the HMD may be a display device of a form, which is worn on the head. For example, the HMD may be used to implement VR, AR or MR. Referring to FIG. 4, the first communication device 410, the second communication device 420 includes a processor 411, 421, a memory 414, 424, one or more Tx/Rx radio frequency (RF) modules 415, 425, a Tx processor 412, 422, an Rx processor 413, 423, and an antenna 416, 426. The Tx/Rx module is also called a transceiver. Each Tx/Rx module 415 transmits a signal each antenna 426. The processor implements the above-described function, process and/or method. The processor 421 may be related to the memory 424 for storing a program code and data. The memory may be referred to as a computer-readable recording medium. More specifically, in the DL (communication from the first communication device to the second communication device), the transmission (TX) processor 412 implements various signal processing functions for the L1 layer (i.e., physical layer). The reception (RX) processor implements various signal processing functions for the L1 layer (i.e., physical layer).

UL (communication from the second communication device to the first communication device) is processed by the first communication device 410 using a method similar to that described in relation to a receiver function in the second communication device 420. Each Tx/Rx module 425 receives a signal through each antenna 426. Each Tx/Rx module provides an RF carrier and information to the RX processor 423. The processor 421 may be related to the memory 424 for storing a program code and data. The memory may be referred to as a computer-readable recording medium.

Signal transmission/reception method in wireless communication system

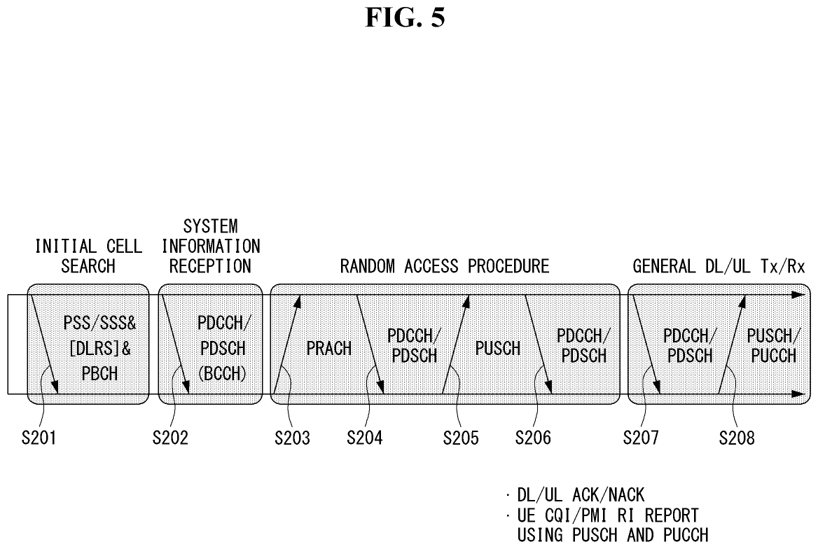

FIG. 5 is a diagram showing an example of a signal transmission/reception method in a wireless communication system. Referring to FIG. 5, when power of a UE is newly turned on or the UE newly enters a cell, the UE performs an initial cell search task, such as performing synchronization with a BS (S501). To this end, the UE may receive a primary synchronization channel (P-SCH) and a secondary synchronization channel (S-SCH) from the BS, may perform synchronization with the BS, and may obtain information, such as a cell ID. In the LTE system and NR system, the P-SCH and the S-SCH are called a primary synchronization signal (PSS) and a secondary synchronization signal (SSS), respectively. After the initial cell search, the UE may obtain broadcast information within the cell by receiving a physical broadcast channel PBCH) form the BS. Meanwhile, the UE may identify a DL channel state by receiving a downlink reference signal (DL RS) in the initial cell search step. After the initial cell search is terminated, the UE may obtain more detailed system information by receiving a physical downlink control channel (PDCCH) and a physical downlink shared channel (PDSCH) based on information carried on the PDCCH (S502).

Meanwhile, if the UE first accesses the BS or does not have a radio resource for signal transmission, the UE may perform a random access procedure (RACH) on the BS (steps S503 to step S506). To this end, the UE may transmit a specific sequence as a preamble through a physical random access channel (PRACH) (S503 and S505), and may receive a random access response (RAR) message for the preamble through a PDSCH corresponding to a PDCCH (S504 and S506). In the case of a contention-based RACH, a contention resolution procedure may be additionally performed.

The UE that has performed the procedure may perform PDCCH/PDSCH reception (S507) and physical uplink shared channel (PUSCH)/physical uplink control channel (PUCCH) transmission (S508) as common uplink/downlink signal transmission processes. In particular, the UE receives downlink control information (DCI) through the PDCCH. The UE monitors a set of PDCCH candidates in monitoring occasions configured in one or more control element sets (CORESETs) on a serving cell based on corresponding search space configurations. A set of PDCCH candidates to be monitored by the UE is defined in the plane of search space sets. The search space set may be a common search space set or a UE-specific search space set. The CORESET is configured with a set of (physical) resource blocks having time duration of 1-3 OFDM symbols. A network may be configured so that the UE has a plurality of CORESETs. The UE monitors PDCCH candidates within one or more search space sets. In this case, the monitoring means that the UE attempts decoding on a PDCCH candidate(s) within the search space. If the UE is successful in the decoding of one of the PDCCH candidates within the search space, the UE determines that it has detected a PDCCH in a corresponding PDCCH candidate, and performs PDSCH reception or PUSCH transmission based on DCI within the detected PDCCH. The PDCCH may be used to schedule DL transmissions on the PDSCH and UL transmissions on the PUSCH. In this case, the DCI on the PDCCH includes downlink assignment (i.e., downlink (DL) grant) related to a downlink shared channel and at least including a modulation and coding format and resource allocation information, or an uplink (DL) grant related to an uplink shared channel and including a modulation and coding format and resource allocation information.

An initial access (IA) procedure in a 5G communication system is additionally described with reference to FIG. 5. A UE may perform cell search, system information acquisition, beam alignment for initial access, DL measurement, etc. based on an SSB. The SSB is interchangeably used with a synchronization signal/physical broadcast channel (SS/PBCH) block.

An SSB is configured with a PSS, an SSS and a PBCH. The SSB is configured with four contiguous OFDM symbols. A PSS, a PBCH, an SSS/PBCH or a PBCH is transmitted for each OFDM symbol. Each of the PSS and the SSS is configured with one OFDM symbol and 127 subcarriers. The PBCH is configured with three OFDM symbols and 576 subcarriers.

Cell search means a process of obtaining, by a UE, the time/frequency synchronization of a cell and detecting the cell identifier (ID) (e.g., physical layer cell ID (PCI)) of the cell. A PSS is used to detect a cell ID within a cell ID group. An SSS is used to detect a cell ID group. A PBCH is used for SSB (time) index detection and half-frame detection.

There are 336 cell ID groups. 3 cell IDs are present for each cell ID group. A total of 1008 cell IDs are present. Information on a cell ID group to which the cell ID of a cell belongs is provided/obtained through the SSS of the cell. Information on a cell ID among the 336 cells within the cell ID is provided/obtained through a PSS.

An SSB is periodically transmitted based on SSB periodicity. Upon performing initial cell search, SSB base periodicity assumed by a UE is defined as 20 ms. After cell access, SSB periodicity may be set as one of {5 ms, 10 ms, 20 ms, 40 ms, 80 ms, 160 ms} by a network (e.g., BS).

Next, system information (SI) acquisition is described. SI is divided into a master information block (MIB) and a plurality of system information blocks (SIBs). SI other than the MIB may be called remaining minimum system information (RMSI). The MIB includes information/parameter for the monitoring of a PDCCH that schedules a PDSCH carrying SystemInformationBlock1 (SIB1), and is transmitted by a BS through the PBCH of an SSB. SIB1 includes information related to the availability of the remaining SIBs (hereafter, SIBx, x is an integer of 2 or more) and scheduling (e.g., transmission periodicity, SI-window size). SIBx includes an SI message, and is transmitted through a PDSCH. Each SI message is transmitted within a periodically occurring time window (i.e., SI-window).

A random access (RA) process in a 5G communication system is additionally described with reference to FIG. 5. A random access process is used for various purposes. For example, a random access process may be used for network initial access, handover, UE-triggered UL data transmission. A UE may obtain UL synchronization and an UL transmission resource through a random access process. The random access process is divided into a contention-based random access process and a contention-free random access process. A detailed procedure for the contention-based random access process is described below.

A UE may transmit a random access preamble through a PRACH as Msg1 of a random access process in the UL. Random access preamble sequences having two different lengths are supported. A long sequence length 839 is applied to subcarrier spacings of 1.25 and 5 kHz, and a short sequence length 139 is applied to subcarrier spacings of 15, 30, 60 and 120 kHz.

When a BS receives the random access preamble from the UE, the BS transmits a random access response (RAR) message (Msg2) to the UE. A PDCCH that schedules a PDSCH carrying an RAR is CRC masked with a random access (RA) radio network temporary identifier (RNTI) (RA-RNTI), and is transmitted. The UE that has detected the PDCCH masked with the RA-RNTI may receive the RAR from the PDSCH scheduled by DCI carried by the PDCCH. The UE identifies whether random access response information for the preamble transmitted by the UE, that is, Msg1, is present within the RAR. Whether random access information for Msg1 transmitted by the UE is present may be determined by determining whether a random access preamble ID for the preamble transmitted by the UE is present. If a response for Msg1 is not present, the UE may retransmit an RACH preamble within a given number, while performing power ramping. The UE calculates PRACH transmission power for the retransmission of the preamble based on the most recent pathloss and a power ramping counter.

The UE may transmit UL transmission as Msg3 of the random access process on an uplink shared channel based on random access response information. Msg3 may include an RRC connection request and a UE identity. As a response to the Msg3, a network may transmit Msg4, which may be treated as a contention resolution message on the DL. The UE may enter an RRC connected state by receiving the Msg4.

Beam management (BM) procedure of 5G communication system

A BM process may be divided into (1) a DL BM process using an SSB or CSI-RS and (2) an UL BM process using a sounding reference signal (SRS). Furthermore, each BM process may include Tx beam sweeping for determining a Tx beam and Rx beam sweeping for determining an Rx beam.

A DL BM process using an SSB is described. The configuration of beam reporting using an SSB is performed when a channel state information (CSI)/beam configuration is performed in RRC_CONNECTED.

A UE receives, from a BS, a CSI-ResourceConfig IE including CSI-SSB-ResourceSetList for SSB resources used for BM. RRC parameter csi-SSB-ResourceSetList indicates a list of SSB resources used for beam management and reporting in one resource set. In this case, the SSB resource set may be configured with {SSBx1, SSBx2, SSBx3, SSBx4, . . . }. SSB indices may be defined from 0 to 63.

The UE receives signals on the SSB resources from the BS based on the CSI-SSB-ResourceSetList. If SSBRI and CSI-RS reportConfig related to the reporting of reference signal received power (RSRP) have been configured, the UE reports the best SSBRI and corresponding RSRP to the BS. For example, if reportQuantity of the CSI-RS reportConfig IE is configured as “ssb-Index-RSRP”, the UE reports the best SSBRI and corresponding RSRP to the BS.

If a CSI-RS resource is configured in an OFDM symbol(s) identical with an SSB and “QCL-TypeD” is applicable, the UE may assume that the CSI-RS and the SSB have been quasi co-located (QCL) in the viewpoint of “QCL-TypeD.” In this case, QCL-TypeD may mean that antenna ports have been QCLed in the viewpoint of a spatial Rx parameter. The UE may apply the same reception beam when it receives the signals of a plurality of DL antenna ports having a QCL-TypeD relation.

Next, a DL BM process using a CSI-RS is described. An Rx beam determination (or refinement) process of a UE and a Tx beam sweeping process of a BS using a CSI-RS are sequentially described. In the Rx beam determination process of the UE, a parameter is repeatedly set as “ON.” In the Tx beam sweeping process of the BS, a parameter is repeatedly set as “OFF.”

First, the Rx beam determination process of a UE is described. The UE receives an NZP CSI-RS resource set IE, including an RRC parameter regarding “repetition”, from a BS through RRC signaling. In this case, the RRC parameter “repetition” has been set as “ON.” The UE repeatedly receives signals on a resource(s) within a CSI-RS resource set in which the RRC parameter “repetition” has been set as “ON” in different OFDM symbols through the same Tx beam (or DL spatial domain transmission filter) of the BS.

The UE determines its own Rx beam. The UE omits CSI reporting. That is, if the RRC parameter “repetition” has been set as “ON”, the UE may omit CSI reporting.

Next, the Tx beam determination process of a BS is described. A UE receives an NZP CSI-RS resource set IE, including an RRC parameter regarding “repetition”, from the BS through RRC signaling. In this case, the RRC parameter “repetition” has been set as “OFF”, and is related to the Tx beam sweeping process of the BS.

The UE receives signals on resources within a CSI-RS resource set in which the RRC parameter “repetition” has been set as “OFF” through different Tx beams (DL spatial domain transmission filter) of the BS. The UE selects (or determines) the best beam. The UE reports, to the BS, the ID (e.g., CRI) of the selected beam and related quality information (e.g., RSRP). That is, the UE reports, to the BS, a CRI and corresponding RSRP, if a CSI-RS is transmitted for BM.

Next, an UL BM process using an SRS is described. A UE receives, from a BS, RRC signaling (e.g., SRS-Config IE) including a use parameter configured (RRC parameter) as “beam management.” The SRS-Config IE is used for an SRS transmission configuration. The SRS-Config IE includes a list of SRS-Resources and a list of SRS-ResourceSets. Each SRS resource set means a set of SRS-resources.

The UE determines Tx beamforming for an SRS resource to be transmitted based on SRS-SpatialRelation Info included in the SRS-Config IE. In this case, SRS-SpatialRelation Info is configured for each SRS resource, and indicates whether to apply the same beamforming as beamforming used in an SSB, CSI-RS or SRS for each SRS resource.

If SRS-SpatialRelationInfo is configured in the SRS resource, the same beamforming as beamforming used in the SSB, CSI-RS or SRS is applied, and transmission is performed. However, if SRS-SpatialRelationInfo is not configured in the SRS resource, the UE randomly determines Tx beamforming and transmits an SRS through the determined Tx beamforming.

Next, a beam failure recovery (BFR) process is described. In a beamformed system, a radio link failure (RLF) frequently occurs due to the rotation, movement or beamforming blockage of a UE. Accordingly, in order to prevent an RLF from occurring frequently, BFR is supported in NR. BFR is similar to a radio link failure recovery process, and may be supported when a UE is aware of a new candidate beam(s). For beam failure detection, a BS configures beam failure detection reference signals in a UE. If the number of beam failure indications from the physical layer of the UE reaches a threshold set by RRC signaling within a period configured by the RRC signaling of the BS, the UE declares a beam failure. After a beam failure is detected, the UE triggers beam failure recovery by initiating a random access process on a PCell, selects a suitable beam, and performs beam failure recovery (if the BS has provided dedicated random access resources for certain beams, they are prioritized by the UE). When the random access procedure is completed, the beam failure recovery is considered to be completed.

Ultra-Reliable and Low Latency Communication (URLLC)

URLLC transmission defined in NR may mean transmission for (1) a relatively low traffic size, (2) a relatively low arrival rate, (3) extremely low latency requirement (e.g., 0.5, 1 ms), (4) relatively short transmission duration (e.g., 2 OFDM symbols), and (5) an urgent service/message. In the case of the UL, in order to satisfy more stringent latency requirements, transmission for a specific type of traffic (e.g., URLLC) needs to be multiplexed with another transmission (e.g., eMBB) that has been previously scheduled. As one scheme related to this, information indicating that a specific resource will be preempted is provided to a previously scheduled UE, and the URLLC UE uses the corresponding resource for UL transmission.

In the case of NR, dynamic resource sharing between eMBB and URLLC is supported. eMBB and URLLC services may be scheduled on non-overlapping time/frequency resources. URLLC transmission may occur in resources scheduled for ongoing eMBB traffic. An eMBB UE may not be aware of whether the PDSCH transmission of a corresponding UE has been partially punctured. The UE may not decode the PDSCH due to corrupted coded bits. NR provides a preemption indication by taking this into consideration. The preemption indication may also be denoted as an interrupted transmission indication.

In relation to a preemption indication, a UE receives a DownlinkPreemption IE through RRC signaling from a BS. When the UE is provided with the DownlinkPreemption IE, the UE is configured with an INT-RNTI provided by a parameter int-RNTI within a DownlinkPreemption IE for the monitoring of a PDCCH that conveys DCI format 2_1. The UE is configured with a set of serving cells by INT-ConfigurationPerServing Cell, including a set of serving cell indices additionally provided by servingCellID, and a corresponding set of locations for fields within DCI format 2_1 by positionInDCI, configured with an information payload size for DCI format 2_1 by dci-PayloadSize, and configured with the indication granularity of time-frequency resources by timeFrequencySect.

The UE receives DCI format 2_1 from the BS based on the DownlinkPreemption IE. When the UE detects DCI format 2_1 for a serving cell within a configured set of serving cells, the UE may assume that there is no transmission to the UE within PRBs and symbols indicated by the DCI format 2_1, among a set of the (last) monitoring period of a monitoring period and a set of symbols to which the DCI format 2_1 belongs. For example, the UE assumes that a signal within a time-frequency resource indicated by preemption is not DL transmission scheduled therefor, and decodes data based on signals reported in the remaining resource region.

Massive MTC (mMTC)

Massive machine type communication (mMTC) is one of 5G scenarios for supporting super connection service for simultaneous communication with many UEs. In this environment, a UE intermittently performs communication at a very low transmission speed and mobility. Accordingly, mMTC has a major object regarding how long will be a UE driven how low the cost is. In relation to the mMTC technology, in 3GPP, MTC and NarrowBand (NB)-IoT are handled.

The mMTC technology has characteristics, such as repetition transmission, frequency hopping, retuning, and a guard period for a PDCCH, a PUCCH, a physical downlink shared channel (PDSCH), and a PUSCH. That is, a PUSCH (or PUCCH (in particular, long PUCCH) or PRACH) including specific information and a PDSCH (or PDCCH) including a response for specific information are repeatedly transmitted. The repetition transmission is performed through frequency hopping. For the repetition transmission, (RF) retuning is performed in a guard period from a first frequency resource to a second frequency resource. Specific information and a response for the specific information may be transmitted/received through a narrowband (e.g., 6 RB (resource block) or 1 RB).

Robot Basic Operation Using 5G Communication

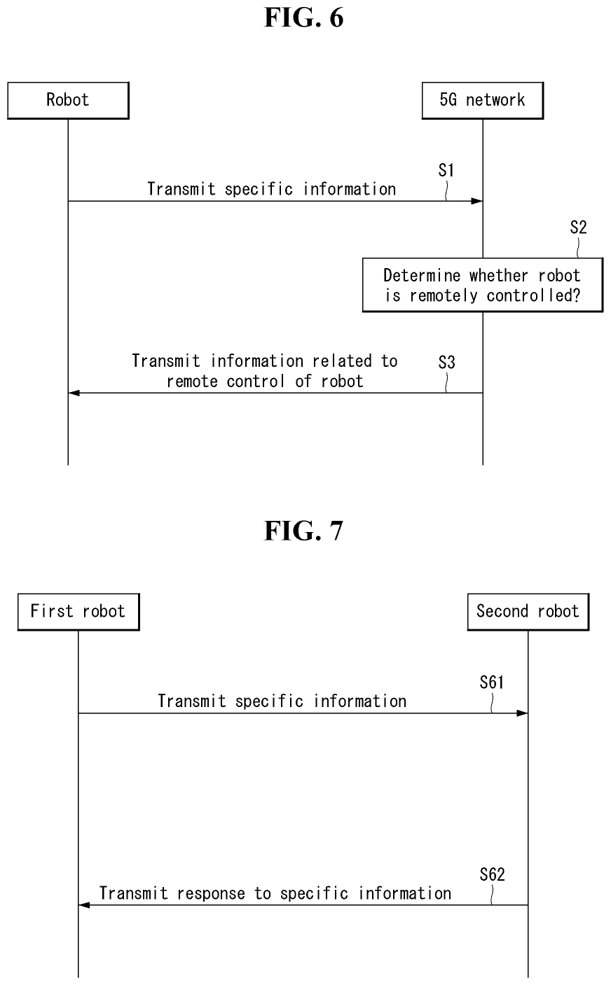

FIG. 6 shows an example of a basic operation of the robot and a 5G network in a 5G communication system. A robot transmits specific information transmission to a 5G network (S1). Furthermore, the 5G network may determine whether the robot is remotely controlled (S2). In this case, the 5G network may include a server or module for performing robot-related remote control. Furthermore, the 5G network may transmit, to the robot, information (or signal) related to the remote control of the robot (S3). Application operation between robot and 5G network in 5G communication system

Hereafter, a robot operation using 5G communication is described more specifically with reference to FIGS. 1 to 6 and the above-described wireless communication technology (BM procedure, URLLC, mMTC). First, a basic procedure of a method to be proposed later in the disclosure and an application operation to which the eMBB technology of 5G communication is applied is described.

As in steps S1 and S3 of FIG. 3, in order fora robot to transmit/receive a signal, information, etc. to/from a 5G network, the robot performs an initial access procedure and a random access procedure along with a 5G network prior to step S1 of FIG. 3. More specifically, in order to obtain DL synchronization and system information, the robot performs an initial access procedure along with the 5G network based on an SSB. In the initial access procedure, a beam management (BM) process and a beam failure recovery process may be added. In a process for the robot to receive a signal from the 5G network, a quasi-co location (QCL) relation may be added.

Furthermore, the robot performs a random access procedure along with the 5G network for UL synchronization acquisition and/or UL transmission. Furthermore, the 5G network may transmit an UL grant for scheduling the transmission of specific information to the robot. Accordingly, the robot transmits specific information to the 5G network based on the UL grant. Furthermore, the 5G network transmits, to the robot, a DL grant for scheduling the transmission of a 5G processing result for the specific information. Accordingly, the 5G network may transmit, to the robot, information (or signal) related to remote control based on the DL grant.

A basic procedure of a method to be proposed later in the disclosure and an application operation to which the URLLC technology of 5G communication is applied is described below. As described above, after a robot performs an initial access procedure and/or a random access procedure along with a 5G network, the robot may receive a DownlinkPreemption IE from the 5G network.

Furthermore, the robot receives, from the 5G network, DCI format 2_1 including pre-emption indication based on the DownlinkPreemption IE. Furthermore, the robot does not perform (or expect or assume) the reception of eMBB data in a resource (PRB and/or OFDM symbol) indicated by the pre-emption indication. Thereafter, if the robot needs to transmit specific information, it may receive an UL grant from the 5G network.

A basic procedure of a method to be proposed later in the disclosure and an application operation to which the mMTC technology of 5G communication is applied is described below. A portion made different due to the application of the mMTC technology among the steps of FIG. 6 is chiefly described.

In step S1 of FIG. 6, the robot receives an UL grant from the 5G network in order to transmit specific information to the 5G network. In this case, the UL grant includes information on the repetition number of transmission of the specific information. The specific information may be repeatedly transmitted based on the information on the repetition number. That is, the robot transmits specific information to the 5G network based on the UL grant. Furthermore, the repetition transmission of the specific information may be performed through frequency hopping. The transmission of first specific information may be performed in a first frequency resource, and the transmission of second specific information may be performed in a second frequency resource. The specific information may be transmitted through the narrowband of 6 resource blocks (RBs) or 1 RB.

Operation Between Robots Using 5G Communication

FIG. 7 illustrates an example of a basic operation between robots using 5G communication. A first robot transmits specific information to a second robot (S61). The second robot transmits, to the first robot, a response to the specific information (S62). Meanwhile, the configuration of an application operation between robots may be different depending on whether a 5G network is involved directly (sidelink communication transmission mode 3) or indirectly (sidelink communication transmission mode 4) in the specific information, the resource allocation of a response to the specific information.

An application operation between robots using 5G communication is described below. First, a method for a 5G network to be directly involved in the resource allocation of signal transmission/reception between robots is described. The 5G network may transmit a DCI format 5A to a first robot for the scheduling of mode 3 transmission (PSCCH and/or PSSCH transmission). In this case, the physical sidelink control channel (PSCCH) is a 5G physical channel for the scheduling of specific information transmission, and the physical sidelink shared channel (PSSCH) is a 5G physical channel for transmitting the specific information. Furthermore, the first robot transmits, to a second robot, an SCI format 1 for the scheduling of specific information transmission on a PSCCH. Furthermore, the first robot transmits specific information to the second robot on the PSSCH.

A method for a 5G network to be indirectly involved in the resource allocation of signal transmission/reception is described below. A first robot senses a resource for mode 4 transmission in a first window. Furthermore, the first robot selects a resource for mode 4 transmission in a second window based on a result of the sensing. In this case, the first window means a sensing window, and the second window means a selection window. The first robot transmits, to the second robot, an SCI format 1 for the scheduling of specific information transmission on a PSCCH based on the selected resource. Furthermore, the first robot transmits specific information to the second robot on a PSSCH.

The above-described structural characteristic of the drone, the 5G communication technology, etc. may be combined with methods to be described, proposed in embodiments of the disclosure, and may be applied or may be supplemented to materialize or clarify the technical characteristics of methods proposed in embodiments of the disclosure.

The following discuss may use certain terms or phrases related to a drone:

Unmanned aerial system: a combination of a UAV and a UAV controller

Unmanned aerial vehicle: an aircraft that is remotely piloted without a human pilot, and it may be represented as an unmanned aerial robot, a drone, or simply a robot.

UAV controller: device used to control a UAV remotely

ATC: Air Traffic Control

NLOS: Non-line-of-sight

UAS: Unmanned Aerial System

UAV: Unmanned Aerial Vehicle

UCAS: Unmanned Aerial Vehicle Collision Avoidance System

UTM: Unmanned Aerial Vehicle Traffic Management

C2: Command and Control

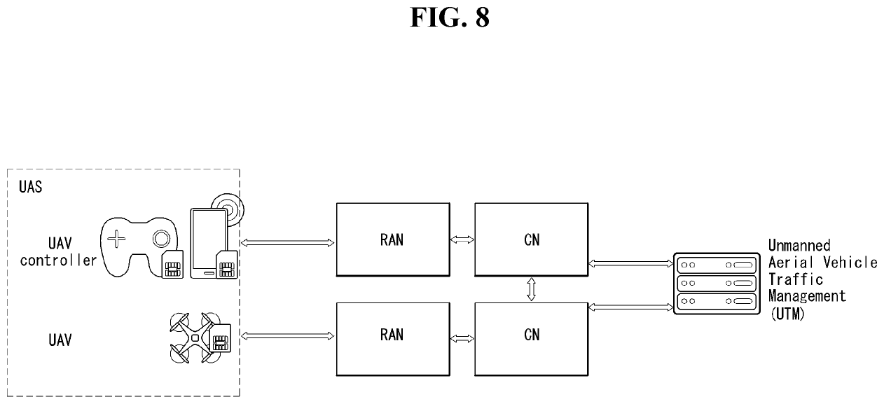

FIG. 8 is a diagram showing an example of the concept diagram of a 3GPP system including a UAS. An unmanned aerial system (UAS) is a combination of an unmanned aerial vehicle (UAV), sometimes called a drone, and a UAV controller. The UAV is an aircraft not including a human pilot device. Instead, the UAV is controlled by a terrestrial operator through a UAV controller, and may have autonomous flight capabilities. A communication system between the UAV and the UAV controller is provided by the 3GPP system. In terms of the size and weight, the range of the UAV is various from a small and light aircraft that is frequently used for recreation purposes to a large and heavy aircraft that may be more suitable for commercial purposes. Regulation requirements are different depending on the range and are different depending on the area.

Communication requirements for a UAS include data uplink and downlink to/from a UAS component for both a serving 3GPP network and a network server, in addition to a command and control (C2) between a UAV and a UAV controller. Unmanned aerial system traffic management (UTM) is used to provide UAS identification, tracking, authorization, enhancement and the regulation of UAS operations and to store data necessary for a UAS for an operation. Furthermore, the UTM enables a certified user (e.g., air traffic control, public safety agency) to query an identity (ID), the meta data of a UAV, and the controller of the UAV.

The 3GPP system enables UTM to connect a UAV and a UAV controller so that the UAV and the UAV controller are identified as a UAS. The 3GPP system enables the UAS to transmit, to the UTM, UAV data that may include the following control information.

Control information: a unique identity (this may be a 3GPP identity), UE capability, manufacturer and model, serial number, take-off weight, location, owner identity, owner address, owner contact point detailed information, owner certification, take-off location, mission type, route data, an operating status of a UAV. The 3GPP system enables a UAS to transmit UAV controller data to UTM. Furthermore, the UAV controller data may include a unique ID (this may be a 3GPP ID), the UE function, location, owner ID, owner address, owner contact point detailed information, owner certification, UAV operator identity confirmation, UAV operator license, UAV operator certification, UAV pilot identity, UAV pilot license, UAV pilot certification and flight plan of a UAV controller.

The functions of a 3GPP system related to a UAS may be summarized as follows. A 3GPP system enables the UAS to transmit different UAS data to UTM based on different certification and an authority level applied to the UAS. A 3GPP system supports a function of expanding UAS data transmitted to UTM along with future UTM and the evolution of a support application. A 3GPP system enables the UAS to transmit an identifier, such as international mobile equipment identity (IMEI), a mobile station international subscriber directory number (MSISDN) or an international mobile subscriber identity (IMSI) or IP address, to UTM based on regulations and security protection.

A 3GPP system enables the UE of a UAS to transmit an identity, such as an IMEI, MSISDN or IMSI or IP address, to UTM. A 3GPP system enables a mobile network operator (MNO) to supplement data transmitted to UTM, along with network-based location information of a UAV and a UAV controller. A 3GPP system enables MNO to be notified of a result of permission so that UTM operates. A 3GPP system enables MNO to permit a UAS certification request only when proper subscription information is present. A 3GPP system provides the ID(s) of a UAS to UTM.

A 3GPP system enables a UAS to update UTM with live location information of a UAV and a UAV controller. A 3GPP system provides UTM with supplement location information of a UAV and a UAV controller. A 3GPP system supports UAVs, and corresponding UAV controllers are connected to other PLMNs at the same time. A 3GPP system provides a function for enabling the corresponding system to obtain UAS information on the support of a 3GPP communication capability designed for a UAS operation.

A 3GPP system supports UAS identification and subscription data capable of distinguishing between a UAS having a UAS capable UE and a USA having a non-UAS capable UE. A 3GPP system supports detection, identification, and the reporting of a problematic UAV(s) and UAV controller to UTM.

In the service requirement of Rel-16 ID_UAS, the UAS is driven by a human operator using a UAV controller in order to control paired UAVs. Both the UAVs and the UAV controller are connected using two individual connections over a 3GPP network for a command and control (C2) communication. The first contents to be taken into consideration with respect to a UAS operation include a mid-air collision danger with another UAV, a UAV control failure danger, an intended UAV misuse danger and various dangers of a user (e.g., business in which the air is shared, leisure activities). Accordingly, in order to avoid a danger in safety, if a 5G network is considered as a transmission network, it is important to provide a UAS service by QoS guarantee for C2 communication.

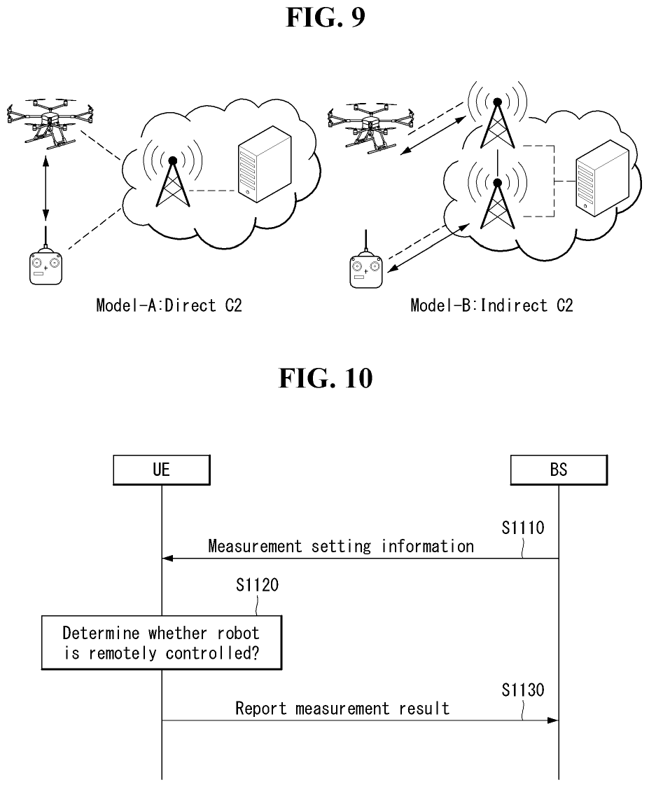

FIG. 9 shows examples of a C2 communication model for a UAV. Model-A is direct C2. A UAV controller and a UAV directly configure a C2 link (or C2 communication) in order to communicate with each other, and are registered with a 5G network using a wireless resource that is provided, configured and scheduled by the 5G network, for direct C2 communication. Model-B is indirect C2. A UAV controller and a UAV establish and register respective unicast C2 communication links for a 5G network, and communicate with each other over the 5G network. Furthermore, the UAV controller and the UAV may be registered with the 5G network through different NG-RAN nodes. The 5G network supports a mechanism for processing the stable routing of C2 communication in any cases. A command and control use C2 communication for forwarding from the UAV controller/UTM to the UAV. C2 communication of this type (model-B) includes two different lower classes for incorporating a different distance between the UAV and the UAV controller/UTM, including a line of sight (VLOS) and a non-line of sight (non-VLOS). Latency of this VLOS traffic type needs to take into consideration a command delivery time, a human response time, and an assistant medium, for example, video streaming, the indication of a transmission waiting time. Accordingly, sustainable latency of the VLOS is shorter than that of the Non-VLOS. A 5G network configures each session for a UAV and a UAV controller. This session communicates with UTM, and may be used for default C2 communication with a UAS.

As part of a registration procedure or service request procedure, a UAV and a UAV controller request a UAS operation from UTM, and provide a pre-defined service class or requested UAS service (e.g., navigational assistance service, weather), identified by an application ID(s), to the UTM. The UTM permits the UAS operation for the UAV and the UAV controller, provides an assigned UAS service, and allocates a temporary UAS-ID to the UAS. The UTM provides a 5G network with information necessary for the C2 communication of the UAS. For example, the information may include a service class, the traffic type of UAS service, requested QoS of the permitted UAS service, and the subscription of the UAS service. When a request to establish C2 communication with the 5G network is made, the UAV and the UAV controller indicate a preferred C2 communication model (e.g., model-B) along with the UAS-ID allocated to the 5G network. If an additional C2 communication connection is to be generated or the configuration of the existing data connection for C2 needs to be changed, the 5G network modifies or allocates one or more QoS flows for C2 communication traffic based on requested QoS and priority in the approved UAS service information and C2 communication of the UAS.

UAV Traffic Management

(1) Centralized UAV Traffic Management

A 3GPP system provides a mechanism that enables UTM to provide a UAV with route data along with flight permission. The 3GPP system forwards, to a UAS, route modification information received from the UTM with latency of less than 500 ms. The 3GPP system needs to forward notification, received from the UTM, to a UAV controller having a waiting time of less than 500 ms.

(2) De-Centralized UAV Traffic Management

A 3GPP system broadcasts the following data (e.g., if it is requested based on another regulation requirement, UAV identities, UAV type, a current location and time, flight route information, current velocity, operation state) so that a UAV identifies a UAV(s) in a short-distance area for collision avoidance. A 3GPP system supports a UAV in order to transmit a message through a network connection for identification between different UAVs. The UAV preserves owner's personal information of a UAV, UAV pilot and UAV operator in the broadcasting of identity information.

A 3GPP system enables a UAV to receive local broadcasting communication transmission service from another UAV in a short distance. A UAV may use direct UAV versus UAV local broadcast communication transmission service in or out of coverage of a 3GPP network, and may use the direct UAV versus UAV local broadcast communication transmission service if transmission/reception UAVs are served by the same or different PLMNs.

A 3GPP system supports the direct UAV versus UAV local broadcast communication transmission service at a relative velocity of a maximum of 320 kmph. The 3GPP system supports the direct UAV versus UAV local broadcast communication transmission service having various types of message payload of 50-1500 bytes other than security-related message elements.

A 3GPP system supports the direct UAV versus UAV local broadcast communication transmission service capable of guaranteeing separation between UAVs. In this case, the UAVs may be considered to have been separated if they are in a horizontal distance of at least 50m or a vertical distance of 30m or both. The 3GPP system supports the direct UAV versus UAV local broadcast communication transmission service that supports the range of a maximum of 600m.

A 3GPP system supports the direct UAV versus UAV local broadcast communication transmission service capable of transmitting a message with frequency of at least 10 message per second, and supports the direct UAV versus UAV local broadcast communication transmission service capable of transmitting a message whose inter-terminal waiting time is a maximum of 100 ms. A UAV may broadcast its own identity locally at least once per second, and may locally broadcast its own identity up to a 500 m range.

Security

A 3GPP system protects data transmission between a UAS and UTM. The 3GPP system provides protection against the spoofing attack of a UAS ID. The 3GPP system permits the non-repudiation of data, transmitted between the UAS and the UTM, in the application layer. The 3GPP system supports the integrity of a different level and the capability capable of providing a personal information protection function with respect to a different connection between the UAS and the UTM, in addition to data transmitted through a UAS and UTM connection. The 3GPP system supports the classified protection of an identity and personal identification information related to the UAS. The 3GPP system supports regulation requirements (e.g., lawful intercept) for UAS traffic.

When a UAS requests the authority capable of accessing UAS data service from an MNO, the MNO performs secondary check (after initial mutual certification or simultaneously with it) in order to establish UAS qualification verification to operate. The MNO is responsible for transmitting and potentially adding additional data to the request so that the UAS operates as unmanned aerial system traffic management (UTM). In this case, the UTM is a 3GPP entity. The UTM is responsible for the approval of the UAS that operates and identifies the qualification verification of the UAS and the UAV operator. One option is that the UTM is managed by an aerial traffic control center. The aerial traffic control center stores all data related to the UAV, the UAV controller, and live location. When the UAS fails in any part of the check, the MNO may reject service for the UAS and thus may reject operation permission.

3GPP Support for Aerial UE (or Drone) Communication

An E-UTRAN-based mechanism that provides an LTE connection to a UE capable of aerial communication is supported through the following functions. Subscription-based aerial UE identification and authorization defined in Section TS 23.401, 4.3.31.

Height reporting based on an event in which the altitude of a UE exceeds a reference altitude threshold configured with a network. Interference detection based on measurement reporting triggered when the number of configured cells (i.e., greater than 1) satisfies a triggering criterion at the same time.

Signaling of flight route information from a UE to an E-UTRAN.

Location information reporting including the horizontal and vertical velocity of a UE.

(1) Subscription-Based Identification of Aerial UE Function

The support of the aerial UE function is stored in user subscription information of an HSS. The HSS transmits the information to an MME in an Attach, Service Request and Tracking Area Update process. The subscription information may be provided from the MME to a base station through an S1 AP initial context setup request during the Attach, tracking area update and service request procedure. Furthermore, in the case of X2-based handover, a source base station (BS) may include subscription information in an X2-AP Handover Request message toward a target BS. More detailed contents are described later. With respect to intra and inter MME S1-based handover, the MME provides subscription information to the target BS after the handover procedure.

(2) Height-Based Reporting for Aerial UE Communication

An aerial UE may be configured with event-based height reporting. The aerial UE transmits height reporting when the altitude of the UE is higher or lower than a set threshold. The reporting includes height and a location.

(3) Interference Detection and Mitigation for Aerial UE Communication

For interference detection, when each (per cell) RSRP value for the number of configured cells satisfies a configured event, an aerial UE may be configured with an RRM event A3, A4 or A5 that triggers measurement reporting. The reporting includes an RRM result and location. For interference mitigation, the aerial UE may be configured with a dedicated UE-specific alpha parameter for PUSCH power control.

(4) Flight Route Information Reporting

An E-UTRAN may request a UE to report flight route information configured with a plurality of middle points defined as 3D locations, as defined in TS 36.355. If the flight route information is available for the UE, the UE reports a waypoint for a configured number. The reporting may also include a time stamp per waypoint if it is configured in the request and available for the UE.

(5) Location Reporting for Aerial UE Communication

Location information for aerial UE communication may include a horizontal and vertical velocity if they have been configured. The location information may be included in the RRM reporting and the height reporting. Hereafter, (1) to (5) of 3GPP support for aerial UE communication is described more specifically.

DL/UL Interference Detection

For DL interference detection, measurements reported by a UE may be useful. UL interference detection may be performed based on measurement in a base station or may be estimated based on measurements reported by a UE. Interference detection can be performed more effectively by improving the existing measurement reporting mechanism. Furthermore, for example, other UE-based information, such as mobility history reporting, speed estimation, a timing advance adjustment value, and location information, may be used by a network in order to help interference detection. More detailed contents of measurement execution are described later.

DL Interference Mitigation

In order to mitigate DL interference in an aerial UE, LTE Release-13 FD-MIMO may be used. Although the density of aerial UEs is high, Rel-13 FD-MIMO may be advantageous in restricting an influence on the DL terrestrial UE throughput, while providing a DL aerial UE throughput that satisfies DL aerial UE throughput requirements. In order to mitigate DL interference in an aerial UE, a directional antenna may be used in the aerial UE. In the case of a high-density aerial UE, a directional antenna in the aerial UE may be advantageous in restricting an influence on a DL terrestrial UE throughput. The DL aerial UE throughput has been improved compared to a case where a non-directional antenna is used in the aerial UE. That is, the directional antenna is used to mitigate interference in the downlink for aerial UEs by reducing interference power from wide angles. In the viewpoint that a LOS direction between an aerial UE and a serving cell is tracked, the following types of capability are taken into consideration:

1) Direction of Travel (DoT): an aerial UE does not recognize the direction of a serving cell LOS, and the antenna direction of the aerial UE is aligned with the DoT.

2) Ideal LOS: an aerial UE perfectly tracks the direction of a serving cell LOS and pilots the line of sight of an antenna toward a serving cell.

3) Non-ideal LOS: an aerial UE tracks the direction of a serving cell LOS, but has an error due to actual restriction.

In order to mitigate DL interference with aerial UEs, beamforming in aerial UEs may be used. Although the density of aerial UEs is high, beamforming in the aerial UEs may be advantageous in restricting an influence on a DL terrestrial UE throughput and improving a DL aerial UE throughput. In order to mitigate DL interference in an aerial UE, intra-site coherent JT CoMP may be used. Although the density of aerial UEs is high, the intra-site coherent JT can improve the throughput of all UEs. An LTE Release-13 coverage extension technology for non-bandwidth restriction devices may also be used. In order to mitigate DL interference in an aerial UE, a coordinated data and control transmission method may be used. An advantage of the coordinated data and control transmission method is to increase an aerial UE throughput, while restricting an influence on a terrestrial UE throughput. It may include signaling for indicating a dedicated DL resource, an option for cell muting/ABS, a procedure update for cell (re)selection, acquisition for being applied to a coordinated cell, and the cell ID of a coordinated cell.

UL Interference Mitigation

In order to mitigate UL interference caused by aerial UEs, an enhanced power control mechanisms may be used. Although the density of aerial UEs is high, the enhanced power control mechanism may be advantageous in restricting an influence on a UL terrestrial UE throughput.

The above power control-based mechanism influences the following contents:

UE-specific partial pathloss compensation factor

UE-specific Po parameter

Neighbor cell interference control parameter

Closed-loop power control

The power control-based mechanism for UL interference mitigation is described more specifically.

1) UE-Specific Partial Pathloss Compensation Factor

The enhancement of the existing open-loop power control mechanism is taken into consideration in the place where a UE-specific partial pathloss compensation factor α_{UE} is introduced. Due to the introduction of the UE-specific partial pathloss compensation factor α_{UE}, different α_{UE} may be configured by comparing an aerial UE with a partial pathloss compensation factor configured in a terrestrial UE.

2) UE-Specific PO Parameter

Aerial UEs are configured with different Po compared with Po configured for terrestrial UEs. The enhancing of the existing power control mechanism is not necessary because the UE-specific Po is already supported in the existing open-loop power control mechanism.

Furthermore, the UE-specific partial pathloss compensation factor α_{UE} and the UE-specific Po may be used in common for uplink interference mitigation. Accordingly, the UE-specific partial path loss compensation factor α_{UE} and the UE-specific Po can improve the uplink throughput of a terrestrial UE, while scarifying the reduced uplink throughput of an aerial UE.

3) Closed-Loop Power Control

Target reception power for an aerial UE is coordinated by taking into consideration serving and neighbor cell measurement reporting. Closed-loop power control for aerial UEs needs to handle a potential high-speed signal change in the sky because aerial UEs may be supported by the sidelobes of base station antennas.

In order to mitigate UL interference attributable to an aerial UE, LTE Release-13 FD-MIMO may be used. In order to mitigate UL interference caused by an aerial UE, a UE-directional antenna may be used. In the case of a high-density aerial UE, a UE-directional antenna may be advantageous in restricting an influence on an UL terrestrial UE throughput. That is, the directional UE antenna is used to reduce uplink interference generated by an aerial UE by reducing a wide angle range of uplink signal power from the aerial UE. The following type of capability is taken into consideration in the viewpoint in which an LOS direction between an aerial UE and a serving cell is tracked:

1) Direction of Travel (DoT): an aerial UE does not recognize the direction of a serving cell LOS, and the antenna direction of the aerial UE is aligned with the DoT.

2) Ideal LOS: an aerial UE perfectly tracks the direction of a serving cell LOS and pilots the line of sight of the antenna toward a serving cell.

3) Non-ideal LOS: an aerial UE tracks the direction of a serving cell LOS, but has an error due to actual restriction.

A UE may align an antenna direction with an LOS direction and amplify power of a useful signal depending on the capability of tracking the direction of an LOS between the aerial UE and a serving cell. Furthermore, UL transmission beamforming may also be used to mitigate UL interference.

Mobility

Mobility performance (e.g., a handover failure, a radio link failure (RLF), handover stop, a time in Qout) of an aerial UE is weakened compared to a terrestrial UE. It is expected that the above-described DL and UL interference mitigation technologies may improve mobility performance for an aerial UE. Better mobility performance in a rural area network than in an urban area network is monitored. Furthermore, the existing handover procedure may be improved to improve mobility performance.

Improvement of a handover procedure for an aerial UE and/or mobility of a handover-related parameter based on location information and information, such as the aerial state of a UE and a flight route plan is now described. A measurement reporting mechanism may be improved in such a way as to define a new event, enhance a trigger condition, and control the quantity of measurement reporting.

The existing mobility enhancement mechanism (e.g., mobility history reporting, mobility state estimation, UE support information) operates for an aerial UE and may be first evaluated if additional improvement is necessary. A parameter related to a handover procedure for an aerial UE may be improved based on aerial state and location information of the UE. The existing measurement reporting mechanism may be improved by defining a new event, enhancing a triggering condition, and controlling the quantity of measurement reporting. Flight route plan information may be used for mobility enhancement. A measurement execution method which may be applied to an aerial UE is described more specifically.

FIG. 10 is a flowchart showing an example of a measurement execution method to which the disclosure may be applied. An aerial UE receives measurement configuration information from a base station (S1010). In this case, a message including the measurement configuration information is called a measurement configuration message. The aerial UE performs measurement based on the measurement configuration information (S1020). If a measurement result satisfies a reporting condition within the measurement configuration information, the aerial UE reports the measurement result to the base station (S1030). A message including the measurement result is called a measurement report message. The measurement configuration information may include the following information.

(1) Measurement object information: this is information on an object on which an aerial UE will perform measurement. The measurement object includes at least one of an intra-frequency measurement object that is an object of measurement within a cell, an inter-frequency measurement object that is an object of inter-cell measurement, or an inter-RAT measurement object that is an object of inter-RAT measurement. For example, the intra-frequency measurement object may indicate a neighbor cell having the same frequency band as a serving cell. The inter-frequency measurement object may indicate a neighbor cell having a frequency band different from that of a serving cell. The inter-RAT measurement object may indicate a neighbor cell of an RAT different from the RAT of a serving cell.

(2) Reporting configuration information: this is information on a reporting condition and reporting type regarding when an aerial UE reports the transmission of a measurement result. The reporting configuration information may be configured with a list of reporting configurations. Each reporting configuration may include a reporting criterion and a reporting format. The reporting criterion is a level in which the transmission of a measurement result by a UE is triggered. The reporting criterion may be the periodicity of measurement reporting or a single event for measurement reporting. The reporting format is information regarding that an aerial UE will configure a measurement result in which type.

An event related to an aerial UE includes (i) an event H1 and (ii) an event H2.

Event H1 (aerial UE height exceeding a threshold)

A UE considers that an entering condition for the event is satisfied when 1) the following defined condition H1-1 is satisfied, and considers that a leaving condition for the event is satisfied when 2) the following defined condition H1-2 is satisfied.

Inequality H1-1(entering condition): Ms−Hys>Thresh+Offset

Inequality H1-2(leaving condition): Ms+Hys<Thresh+Offset

In the above equation, the variables are defined as follows.

Ms is an aerial UE height and does not take any offset into consideration. Hys is a hysteresis parameter (i.e., h1-hysteresis as defined in ReportConfigEUTRA) for an event. Thresh is a reference threshold parameter variable for the event designated in MeasConfig (i.e., heightThreshRef defined within MeasConfig). Offset is an offset value for heightThreshRef for obtaining an absolute threshold for the event (i.e., h1-ThresholdOffset defined in ReportConfigEUTRA). Ms is indicated in meters. Thresh is represented in the same unit as Ms.

Event H2 (Aerial UE Height of Less than Threshold)

A UE considers that an entering condition for an event is satisfied 1) the following defined condition H2-1 is satisfied, and considers that a leaving condition for the event is satisfied 2) when the following defined condition H2-2 is satisfied.

Inequality H2-1(entering condition): Ms+Hys<Thresh+Offset

Inequality H2-2(leaving condition): Ms−Hys>Thresh+Offset

In the above equation, the variables are defined as follows.

Ms is an aerial UE height and does not take any offset into consideration. Hys is a hysteresis parameter (i.e., h1-hysteresis as defined in ReportConfigEUTRA) for an event. Thresh is a reference threshold parameter variable for the event designated in MeasConfig (i.e., heightThreshRef defined within MeasConfig). Offset is an offset value for heightThreshRef for obtaining an absolute threshold for the event (i.e., h2-ThresholdOffset defined in ReportConfigEUTRA). Ms is indicated in meters. Thresh is represented in the same unit as Ms.

(3) Measurement identity information: this is information on a measurement identity by which an aerial UE determines to report which measurement object using which type by associating the measurement object and a reporting configuration. The measurement identity information is included in a measurement report message, and may indicate that a measurement result is related to which measurement object and that measurement reporting has occurred according to which reporting condition.

(4) Quantity configuration information: this is information on about a parameter for configuration of measurement unit, reporting unit and/or filtering of measurement result value.

(5) Measurement gap information: this is information on a measurement gap, that is, an interval which may be used by an aerial UE in order to perform only measurement without taking into consideration data transmission with a serving cell because downlink transmission or uplink transmission has not been scheduled in the aerial UE.

In order to perform a measurement procedure, an aerial UE has a measurement object list, a measurement reporting configuration list, and a measurement identity list. If a measurement result of the aerial UE satisfies a configured event, the UE transmits a measurement report message to a base station.

In this case, the following parameters may be included in a UE-EUTRA-Capability Information Element in relation to the measurement reporting of the aerial UE. IE UE-EUTRA-Capability is used to forward, to a network, an E-RA UE Radio Access Capability parameter and a function group indicator for an essential function. IE UE-EUTRA-Capability is transmitted in an E-UTRA or another RAT. Table 1 is a table showing an example of the UE-EUTRA-Capability IE.

TABLE 1
-- ASN1START . . . . . MeasParameters-v1530 : := SEQUENCE {qoe-MeasReport-r15
ENUMERATED {supported} OPTIONAL, qoe-MTSI-MeasReport-r15
ENUMERATED {supported} OPTIONAL, ca-IdleModeMeasurements-r15
ENUMERATED {supported} OPTIONAL, ca-IdleModeValidityArea-r15
ENUMERATED {supported} OPTIONAL, heightMeas-r15 ENUMERATED
{supported} OPTIONAL, multipleCellsMeasExtension-r15 ENUMERATED
{supported} OPTIONAL} . . . . .

The heightMeas-r15 field defines whether a UE supports height-based measurement reporting defined in TS 36.331. As defined in TS 23.401, to support this function with respect to a UE having aerial UE subscription is essential. The multipleCellsMeasExtension-r15 field defines whether a UE supports measurement reporting triggered based on a plurality of cells. As defined in TS 23.401, to support this function with respect to a UE having aerial UE subscription is essential.

UAV UE Identification

A UE may indicate a radio capability in a network which may be used to identify a UE having a related function for supporting a UAV-related function in an LTE network. A permission that enables a UE to function as an aerial UE in the 3GPP network may be aware based on subscription information transmitted from the MME to the RAN through S1 signaling. Actual “aerial use” certification/license/restriction of a UE and a method of incorporating it into subscription information may be provided from a Non-3GPP node to a 3GPP node. A UE in flight may be identified using UE-based reporting (e.g., mode indication, altitude or location information during flight, an enhanced measurement reporting mechanism (e.g., the introduction of a new event) or based on mobility history information available in a network.

Subscription Handling for Aerial UE

The following description relates to subscription information processing for supporting an aerial UE function through the E-UTRAN defined in TS 36.300 and TS 36.331. An eNB supporting aerial UE function handling uses information for each user, provided by the MME, in order to determine whether the UE can use the aerial UE function. The support of the aerial UE function is stored in subscription information of a user in the HSS. The HSS transmits the information to the MME through a location update message during an attach and tracking area update procedure. A home operator may cancel the subscription approval of the user for operating the aerial UE at any time. The MME supporting the aerial UE function provides the eNB with subscription information of the user for aerial UE approval through an S1 AP initial context setup request during the attach, tracking area update and service request procedure.

An object of an initial context configuration procedure is to establish all required initial UE context, including E-RAB context, a security key, a handover restriction list, a UE radio function, and a UE security function. The procedure uses UE-related signaling. In the case of Inter-RAT handover to intra- and inter-MME S1 handover (intra RAT) or E-UTRAN, aerial UE subscription information of a user includes an S1-AP UE context modification request message transmitted to a target BS after a handover procedure.

An object of a UE context change procedure is to partially change UE context configured as a security key or a subscriber profile ID for RAT/frequency priority, for example. The procedure uses UE-related signaling. In the case of X2-based handover, aerial UE subscription information of a user is transmitted to a target BS as follows: If a source BS supports the aerial UE function and aerial UE subscription information of a user is included in UE context, the source BS includes corresponding information in the X2-AP handover request message of a target BS.

An MME transmits, to the target BS, the aerial UE subscription information in a Path Switch Request Acknowledge message. An object of a handover resource allocation procedure is to secure, by a target BS, a resource for the handover of a UE. If aerial UE subscription information is changed, updated aerial UE subscription information is included in an S1-AP UE context modification request message transmitted to a BS.

Table 2 is a table showing an example of the aerial UE subscription information.

TABLE 2

| IE/Group Name | Presence | Range | IE type and reference |
|---|---|---|---|
| Aerial UE | M | | ENUMERATED |
| subscription | | | (allowed, |
| information | | | not allowed, . . . ) |

Aerial UE subscription information is used by a BS in order to know whether a UE can use the aerial UE function.

Combination of Drone and eMBB

A 3GPP system can support data transmission for a UAV (aerial UE or drone) and for an eMBB user at the same time. A base station may need to support data transmission for an aerial UAV and a terrestrial eMBB user at the same time under a restricted bandwidth resource. For example, in a live broadcasting scenario, a UAV of 100 meters or more requires a high transmission speed and a wide bandwidth because it has to transmit, to a base station, a captured figure or video in real time. At the same time, the base station needs to provide a requested data rate to terrestrial users (e.g., eMBB users). Furthermore, interference between the two types of communications needs to be minimized.

Block Diagram of AI Device

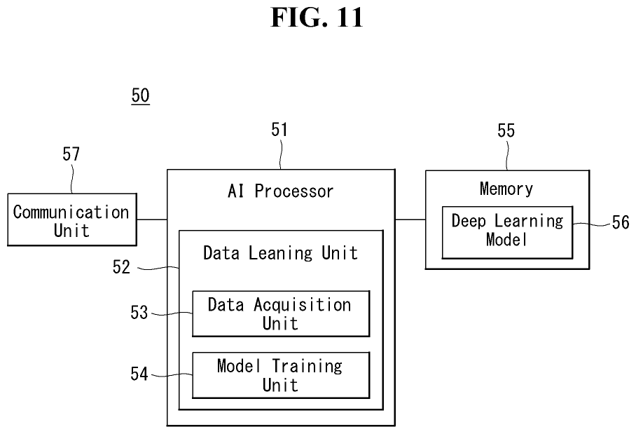

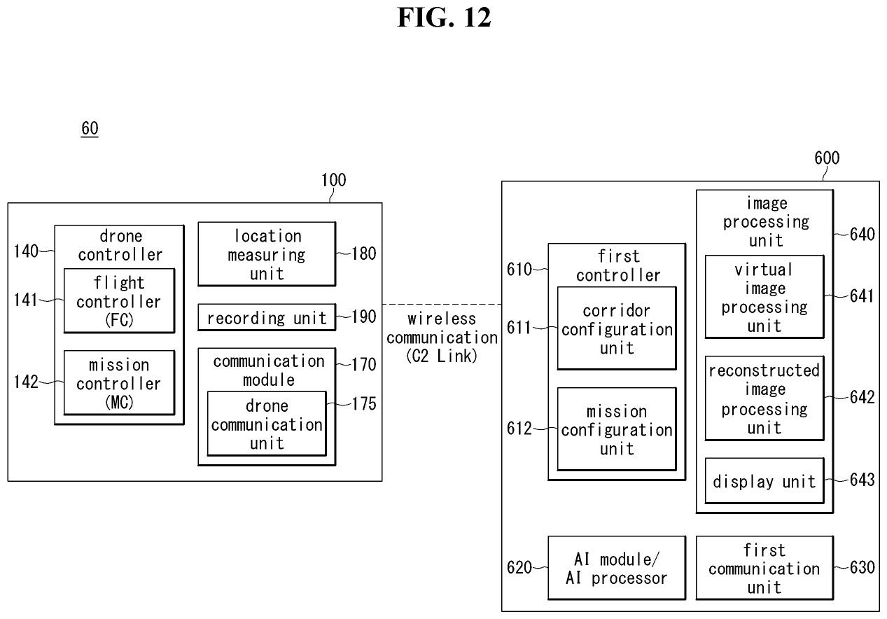

FIG. 11 is a block diagram illustrating an AI device according to an embodiment of the disclosure. The AI device 50 may include an electronic device including an AI module capable of performing AI processing or a server including the AI module. The AI device 50 may be included as at least some component of the device 600 for controlling the UAV according to an embodiment of the disclosure, as shown in FIG. 12, to perform AI processing in the device or in a terminal. In other words, the AI device 50 may be embedded in the device 600 for controlling the UAV 100 according to an embodiment of the disclosure, as shown in FIG. 12. Where the AI device 50 is included as at least some component of the device 600 shown in FIG. 12, the AI device 50 may be configured in the form of an AI module or an AI processor and be embedded in the device 600 to perform AI processing.

In the disclosure, AI processing may include all computation and tasks for the device 600 of FIG. 12 to control the UAV 100. For example, the device 600 of FIG. 12 may receive sensing data measured by the UAV 100 of FIG. 2 via the sensing unit 130 or flight data generated upon flight, via the drone controller 140, perform machine learning thereon, recognize, process, and/or determine what the UAV 100 has sensed, and generate a control signal for the UAV 100. Further, the AI processing may receive, from the UAV 100, data obtained by interaction with the other electronic devices equipped in the UAV 100, such as the storage unit 150, motor unit 12, task unit 40, and communication module 170, and other unmentioned electronic devices that may be equipped in the UAV 100, perform AI processing thereon, and then control various functions and operations for the flight and/or mission fulfilment of the UAV 100.

The AI device 50 may include an AI processor 51, a memory 55, and/or a communication unit 57. The AI device 50, which is a computing device that can learn a neural network, may be implemented as various electronic devices such as a server, a desktop PC, a notebook PC, and a tablet PC.

The AI processor 51 can learn a neural network using programs stored in the memory 55. In particular, the AI processor 51 can learn a neural network for recognizing data related to vehicles. Here, the neural network for recognizing data related to vehicles may be designed to simulate the brain structure of human on a computer and may include a plurality of network nodes having weights and simulating the neurons of human neural network. The plurality of network nodes can transmit and receive data in accordance with each connection relationship to simulate the synaptic activity of neurons in which neurons transmit and receive signals through synapses. Here, the neural network may include a deep learning model developed from a neural network model. In the deep learning model, a plurality of network nodes is positioned in different layers and can transmit and receive data in accordance with a convolution connection relationship. The neural network, for example, includes various deep learning techniques such as deep neural networks (DNN), convolutional deep neural networks (CNN), recurrent neural networks (RNN), a restricted Boltzmann machine (RBM), deep belief networks (DBN), and a deep Q-network, and can be applied to fields such as computer vision, voice recognition, natural language processing, and voice/signal processing. Meanwhile, a processor that performs the functions described above may be a general purpose processor (e.g., a CPU), but may be an AI-only processor (e.g., a GPU) for artificial intelligence learning.

The memory 55 can store various programs and data for the operation of the AI device 50. The memory 55 may be a nonvolatile memory, a volatile memory, a flash-memory, a hard disk drive (HDD), a solid state drive (SDD), or the like. The memory 55 is accessed by the AI processor 51 and reading-out/recording/correcting/deleting/updating, etc. of data by the AI processor 51 can be performed. Further, the memory 55 can store a neural network model (e.g., a deep learning model 56) generated through a learning algorithm for data classification/recognition according to an embodiment of the disclosure.

Meanwhile, the AI processor 51 may include a data learning unit 52 that learns a neural network for data classification/recognition. The data learning unit 52 can learn references about what learning data are used and how to classify and recognize data using the learning data in order to determine data classification/recognition. The data learning unit 52 can learn a deep learning model by acquiring learning data to be used for learning and by applying the acquired learning data to the deep learning model.

The data learning unit 52 may be manufactured in the type of at least one hardware chip and mounted on the AI device 50. For example, the data learning unit 52 may be manufactured in a hardware chip type only for artificial intelligence, and may be manufactured as a part of a general purpose processor (CPU) or a graphics processing unit (GPU) and mounted on the AI device 50. Further, the data learning unit 52 may be implemented as a software module. When the data leaning unit 52 is implemented as a software module (or a program module including instructions), the software module may be stored in non-transitory computer readable media that can be read through a computer. In this case, at least one software module may be provided by an OS (operating system) or may be provided by an application.

The data learning unit 52 may include a learning data acquiring unit 53 and a model learning unit 54. The learning data acquiring unit 53 can acquire learning data required for a neural network model for classifying and recognizing data. For example, the learning data acquiring unit 53 can acquire, as learning data, vehicle data and/or sample data to be input to a neural network model.

The model learning unit 54 can perform learning such that a neural network model has a determination reference about how to classify predetermined data, using the acquired learning data. In this case, the model learning unit 54 can train a neural network model through supervised learning that uses at least some of learning data as a determination reference. Alternatively, the model learning data 54 can train a neural network model through unsupervised learning that finds out a determination reference by performing learning by itself using learning data without supervision. Further, the model learning unit 54 can train a neural network model through reinforcement learning using feedback about whether the result of situation determination according to learning is correct. Further, the model learning unit 54 can train a neural network model using a learning algorithm including error back-propagation or gradient decent.

When a neural network model is learned, the model learning unit 54 can store the learned neural network model in the memory. The model learning unit 54 may store the learned neural network model in the memory of a server connected with the AI device 50 through a wire or wireless network. The data learning unit 52 may further include a learning data preprocessor (not shown) and a learning data selector (not shown) to improve the analysis result of a recognition model or reduce resources or time for generating a recognition model.

The learning data preprocessor can preprocess acquired data such that the acquired data can be used in learning for situation determination. For example, the learning data preprocessor can process acquired data in a predetermined format such that the model learning unit 54 can use learning data acquired for learning for image recognition.

Further, the learning data selector can select data for learning from the learning data acquired by the learning data acquiring unit 53 or the learning data preprocessed by the preprocessor. The selected learning data can be provided to the model learning unit 54. For example, the learning data selector can select only data for objects included in a specific area as learning data by detecting the specific area in an image acquired through a camera of a vehicle.

Further, the data learning unit 52 may further include a model estimator (not shown) to improve the analysis result of a neural network model. The model estimator inputs estimation data to a neural network model, and when an analysis result output from the estimation data does not satisfy a predetermined reference, it can make the model learning unit 52 perform learning again. In this case, the estimation data may be data defined in advance for estimating a recognition model. For example, when the number or ratio of estimation data with an incorrect analysis result of the analysis result of a recognition model learned with respect to estimation data exceeds a predetermined threshold, the model estimator can estimate that a predetermined reference is not satisfied.

The communication unit 57 can transmit the AI processing result by the AI processor 51 to an external electronic device. Here, the external electronic device may be defined as an autonomous vehicle. Further, the AI device 50 may be defined as another vehicle or a 5G network that communicates with the autonomous vehicle. Meanwhile, the AI device 50 may be implemented by being functionally embedded in an autonomous module included in a vehicle. Further, the 5G network may include a server or a module that performs control related to autonomous driving.

Meanwhile, the AI device 50 shown in FIG. 4 was functionally separately described into the AI processor 51, the memory 55, the communication unit 57, etc., but it should be noted that the aforementioned components may be integrated in one module and referred to as an AI module. The above-described 5G communication technology may be combined with the methods described below according to the disclosure or may be provided to specify or clarify the technical features of the methods proposed herein.

The components of a device and system for controlling a UAV according to an embodiment of the disclosure are described below in detail with reference to FIG. 12. FIG. 12 is a block diagram illustrating main components of a device and system for controlling a UAV according to an embodiment of the disclosure.

Referring to FIG. 12, according to an embodiment of the disclosure, a system 60 for controlling a UAV includes a UAV 100 and a device 600 for controlling the UAV 100. The UAV 100 of FIG. 12 may include all of the components of the UAV 100 of FIG. 2. The components of the UAV 100 of FIG. 2 are selectively illustrated in FIG. 12. This is intended to more specifically describe the components of the UAV 100, which are not shown in FIG. 2, with reference to FIG. 12 for illustration purposes. Thus, the description of the UAV 100 made above in connection with FIG. 2 may apply to the description of the UAV 100 of FIG. 12. To avoid an unnecessary duplicate description, if the respective UAVs 100 of FIGS. 2 and 12 include the same components, the same components are shown in only one of the two figures and are omitted from the other figure, with no detailed description thereof given.

For illustration purposes, as an example of the UAV 100, a multi-copter-type drone 100 is described. Referring to FIG. 12, according to an embodiment of the disclosure, the UAV 100, e.g., a drone 100, (hereinafter, referred to as a drone) includes a drone controller 140. The drone controller 140 includes a flight controller 141 and a mission controller 142 to control the flight and mission fulfilment of the drone 100.

The flight controller 141 controls the motors 12 and propellers 11 of FIG. 1 to control the flight of the drone 100. In other words, the flight controller 141 may be configured to control the rotation speed and direction of the motor 12 or to adjust such elements as the variables or pitch angle of the propeller 11.

The mission controller 142 controls the functions that the drone 100 needs to carry out during flight. For example, where the drone 100 flies to record a specific object, the mission controller 142 is configured to adjust the gimbal equipped in the drone 100 or the lens magnification or aperture of the camera of the drone 100 to be able to photograph or video-record the specific object in the destination or while flying to the destination. Further, the mission controller 142 may previously calculate data for the flight speed, orientation, and/or location of the drone 100 to achieve the mission and transmit the resultant values of the calculation to the flight controller 141, allowing the flight controller 141 to fly the drone 100 based on the received resultant values.

The drone 100 according to an embodiment, as shown in FIG. 12, may further include a location measuring unit 180 and a recording unit 190. The location measuring unit 180 is configured to be able to obtain the GPS coordinates of the drone 100 using the GPS satellite. Thus, the current location of the drone 100 may be grasped via the location measuring unit 180.

The recording unit 190 may include a camera and is configured to be able to photograph and/or video-record the object using the camera. The recording unit 190 may record the object and generate image data. The generated image data is transmitted to the device 600 for controlling the UAV according to an embodiment of the disclosure, via the drone communication unit 175 included in the communication module 170.

Referring to FIG. 12, the device 600 for controlling a UAV according to an embodiment of the disclosure includes a first controller 610, an AI processor 620, and a first communication unit (also referred to as a communication interface device or antenna) 630. The device 600 may further include an image processing unit 640. The first controller 610, AI processor 620, and the image processing unit 640 may be collectively referred to as a controller or processor.

The first controller 610 is configured to generate a control signal for controlling the flight and orientation of the UAV 100, i.e., the drone 100, and configure a corridor (or flight path) along which the drone 100 is to fly. The first controller 610 may further include a corridor configuration unit 611 to configure a corridor along which the drone 100 is to fly. The corridor configuration unit 611 may configure a corridor along which the drone 100 is to fly, using an electronic map and/or satellite photos pre-stored in a storage unit and/or database of the device 600. However, the corridor configuration unit 611 may configure a corridor along which the drone 100 is to fly, using an electronic map and/or satellite photos stored in a device other than the storage unit and/or database of the device 600.

The first controller 610 may configure a mission that the drone 100 needs to carry out while flying along the configured corridor. The first controller 610 may grasp the mission that the user wants the drone 100 to fulfill, via the mission configuration unit 612 and, to perform the mission desired by the user, may configure necessary flight information, sensor operation, and whether functions work, and determine the time of operation.

For example, it is assumed that the user enters a mission for the drone 100 to carry out, via the device 600. Here, the mission the drone 100 needs to carry out is assumed to be a patrol. In this case, the mission configuration unit 612 may configure flight information, sensor operation, and whether functions work to allow the drone 100 to repeatedly fly in an orbit pattern in the air above a predetermined area and may transfer the configured values to allow the corridor configuration unit 611 to yield an optimal corridor for fulfilling the mission.

The AI processor 620 automatically gathers and machine-learns the electronic map or satellite photos for the area where the drone 100 is planned to fly and/or where the corridor has been configured and provides the resultant data of the machine learning to the first controller 610. The first controller 610 configures the corridor along which the drone is to fly, based on the learning result data.

The AI processor 620 machine-learns the video the drone 100 has recorded using the recording unit 190 during flight and recognizes and detects obstacles and/or landmarks present on the corridor the drone 100 is to fly. The AI processor 620 provides the learning result data to the first controller 610, allowing the first controller 610 to configure a detour corridor for avoiding the obstacles and/or landmarks based on the learning result data.

In other words, the AI processor 620 may machine-learn the topography information including the electronic map and satellite photos for the areas the corridor of the drone 100 passes through and the video the drone 100 has recorded during flight, recognize and detect the obstacles and/or landmarks present on the corridor, and determine whether an obstacle and/or landmark is present on the corridor.

The AI processor 620 of FIG. 12 may include the same components as the AI processor 51 of FIG. 11. Thus, although not shown in FIG. 12, the AI processor 620 of FIG. 12 may further include a memory 55 for storing a deep-learning model 56, and the deep-learning model 56 includes models for deep-learning images and/or videos. Upon determining that an obstacle is present on the corridor, based on the topography information including the electronic map and satellite photos for the area where the corridor has been configured and the learning result data for the recorded video, the AI processor 620 configures a detour corridor for flying while getting around the obstacle.

For the drone 100 to minimize fuel consumption, the corridor configuration unit 611 may analyze whether the corridor it has automatically configured has a segment where the drone 100 needs bursting. However, such analysis function need not be embedded in the corridor configuration unit 611 but may rather be carried out by the AI processor 620. In this case, the corridor configuration unit 611 may transmit the corridor it has automatically configured to the AI processor 620 to be able to recognize and detect the segment, where the drone 100 requires bursting, in the corridor configured via AI processing and machine learning.

Meanwhile, where the corridor configuration unit 611 itself analyzes whether the corridor has a segment where the drone 100 needs bursting, the corridor configuration unit 611 may calculate variations in azimuth, which indicates the flight direction of the drone 100, altitude, number of turns of the propellers, orientation, and speed at, at least, one or more way points included in the corridor so as to determine whether the corridor has a segment requiring the drone 100's bursting. The corridor configuration unit 611 may determine whether the drone 100 is to fly through the way point depending on whether the variation exceeds a predetermined level.

Specifically, the corridor configuration unit 611 may calculate the angle formed by at least three way points sequentially connected among all the way points included in the configured corridor and determine whether the drone 100 is to pass through all of the three way points depending on whether the angle exceeds a predetermined value.

When the angle formed by the at least one three way points sequentially connected is less than the predetermined value, the corridor configuration unit 611 may determine whether the area with the way points and/or its nearby area has a landmark, based on the topography information including the electronic map and satellite photos for the corridor-configured area and the data resultant from machine learning on the video recorded by the drone 100.

In other words, when the angle formed by the at least three way points sequentially connected is less than the predetermined value, the corridor configuration unit 611 may determine that in the segment the drone 100 need not bursting. In the segment, the electronic map and satellite photos for the segment and the video recorded by the drone 100 may be analyzed via the image analysis function of the AI processor 620, thereby determining whether a landmark is present in the segment. If no landmark is present in the segment, it is determined that there is no goal and/or object necessary for the drone 100 to fulfill the mission, and the corridor may be configured for the drone 100 to pass through none of the way points configured in the segment.

For example, the device 600 according to an embodiment of the disclosure is assumed to have determined that the angle formed by three way points sequentially connected in a specific segment among all the way points included in the corridor is an obtuse angle and no landmark is present in the specific segment and its nearby area, using the corridor configuration unit 611 and/or the AI processor 620.

In this case, the corridor configuration unit 611 may modify the existing corridor for the drone 100 not to fly through the second way point among the three way points sequentially connected. The first controller 610 may generate a control signal to enable the drone 100 to fly by the second way point among the three way points sequentially connected according to the modified corridor of the corridor configuration unit 611 and transmit the control signal to the drone 100 via the first communication unit 630. The drone 100 may fly by the second way point among the three sequentially connected way points and directly fly to the third way point among the three sequentially connected way points, thus minimizing the battery and/or fuel consumption required for the flight of the drone 100.

“Fly-by” means an air navigation method adopted for fixed wing aircrafts. The device 600 according to the disclosure may apply the air navigation method adopted for fixed wing aircrafts to the drone 100, thereby minimizing the battery and/or fuel consumption required for the flight of the drone 100.

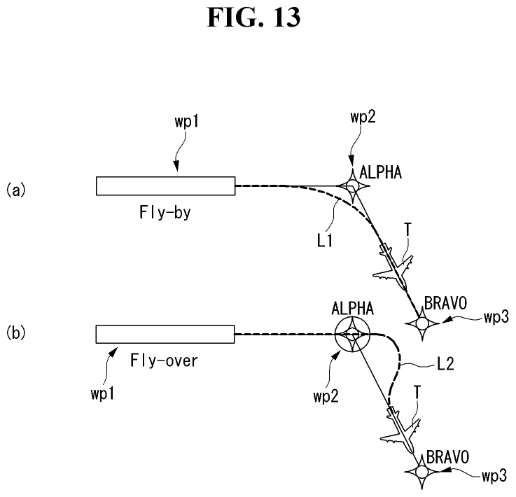

Referring to FIG. 13, an example navigation method applicable to the UAV 100, i.e., the drone 100, according to the disclosure is described. FIG. 13 is a view illustrating an example method in which a UAV flies along a corridor according to the disclosure. Referring to FIG. 13 (section a), an aircraft T may be identified which flies along three sequentially connected way points, i.e., a first way point wp1, a second way point wp2, and a third way point wp3. In this case, it may be identified that the aircraft T adopts a corridor L1 along which the aircraft T departs from the first way point wp1 to the second way point wp2 but, without passing through the second way point wp2, modifies the corridor to fly directly to the third way point wp3. The navigation such as of L1 is fly-by navigation.

Referring to FIG. 13 (section b), it may be identified that the aircraft T adopts a corridor L2 along which the aircraft T departs from the first way point wp1 to the second way point wp2 and, immediately after passing through the second way point wp2, continues to advance without turning its head, and modifies the corridor and turns its head to the third way point wp3 and returns. The navigation such as of L2 is fly-over navigation.

Upon flying by as shown in FIG. 13(a), the aircraft T may reduce both the flight time and the battery and/or fuel consumption. However, since the aircraft T has not passed through the second way point wp2, it is hard for the aircraft T to fulfill a specific mission, e.g., land recording, at the second way point wp2.

In contrast, upon flying over as shown in FIG. 13(b), the aircraft T passes through the second way point wp2 and circles around the second way point wp2 for a predetermined time. Thus, it is very appropriate for the aircraft T to fulfill a specific mission, e.g., land recording, at the second way point wp2. Further, upon flying over as shown in FIG. 13(b), the aircraft T circulates around the second way point wp2 for a predetermined time while passing through the second way point wp2 and may thus be expected to consume slightly more battery and/or fuel while taking a longer flight time. However, since the aircraft T need not burst or sharply turn while passing through the second way point wp2, there would not be a significant increase in flight time and battery and/or fuel consumption as compared with when the aircraft T flies from the second way point wp2 directly to the third way point wp3. Thus, the control of the flight of the UAV using the device 600 and system 60 capable of controlling a UAV according to the disclosure may minimize the flight time and battery and/or fuel consumption.

Further, according to the disclosure, the corridor configuration unit 611 may configure an inter-aircraft corridor width for the drone 100 directly controlled by the device 600. In other words, where the drone 100 directly controlled by the device 600 is likely to collide head-on with another drone while flying, the device 600 may recognize the presence of the other drone by various sensors equipped in the sensing unit (130 of FIG. 2) and/or air traffic control information received by the device 600 and allow the drone 100 to pass, a predetermined distance away from the other drone.

To that end, the corridor configuration unit 611 configures the corridor to have an inter-aircraft corridor width to allow the drone 100 which runs into another UAV to fly around the other UAV, a predetermined distance away from the other UAV, based on the data resultant from learning the air traffic control information and traffic for the area where the drone 100 flies, along with the electronic map and satellite photos by the AI processor 620, information from the sensors included in the drone 100, and aircraft data including the current and future locations, speed, altitude, and orientation information for the drone 100. Alternatively, the corridor width may be configured by the user's direct entry of a predetermined value to the device 600. Thus, the device 600 and system 60 according to the disclosure may previously configure the inter-aircraft corridor width, thereby preventing collision between the drone 100 and other UAV.

The first communication unit 630 may be configured to exchange information with the UAV 100, i.e., the drone 100, enabling real-time communication of a high volume of data between the two devices. C2 link or 5G network technology may be applied to such data communication method.

The first communication unit 630 may transmit the data, which has been transmitted from the first controller 610, AI processor 620, and image processing unit 640 included in the device 600, to a device other than the device 600 and may receive the data received from the other device. In particular, the first communication unit 630 may transmit the configured corridor and control signal generated by the first controller 610 to control the drone 100 to the drone 100, allowing the device 600 to directly control the drone 100.

The image processing unit 640 may receive the image data recorded by the drone 100 via the first communication unit 630, process the image data, and output the processed image data to the display device included in the device 600. Further, the image processing unit 640 may process the image data recorded by the drone 100 and transmit the processed image data to the user's terminal 300 shown in FIG. 3 via the first communication unit 630, allowing the video recorded by the drone 100 to be output via the terminal 300 in real-time.

Meanwhile, the image processing unit 640 may further include a virtual image processing unit 641 that generates and processes a virtual image to overlap the video recorded by the drone 100. The virtual image herein includes figures, numbers, or letters used in a head-up display (HUD). In other words, the virtual image means an image including various pieces of information, such as speed, altitude, direction, or orientation used for the head-up display.

Further, the image processing unit 640 may further include a composite image processing unit 642 that overlays the virtual image generated from the virtual image processing unit 641 on the video recorded by the drone 100 and outputs the result. For example, the composite image processing unit 642 may overlay the information for the speed, altitude, direction, and orientation of the drone 100, generated from the virtual image processing unit 641, on the video recorded at the head of the drone 100 while the drone 100 flies while simultaneously allowing the information for the speed, altitude, direction, and orientation of the drone 100 generated from the virtual image processing unit 641 to be synced with the video recorded at the head of the drone 100.

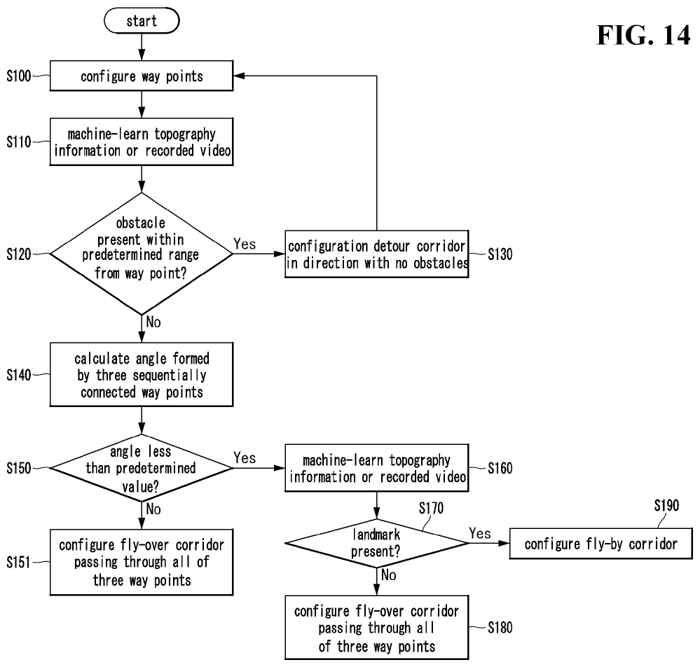

A method of controlling a UAV using a device or system according to an embodiment of the disclosure is described below with reference to FIGS. 14 to 17. In describing the method of controlling a UAV using a device or system according to an embodiment of the disclosure, the same reference numbers may be used to refer to the same components as those in the device 600 or system 60 for controlling a UAV described above, and no duplicate description is given.

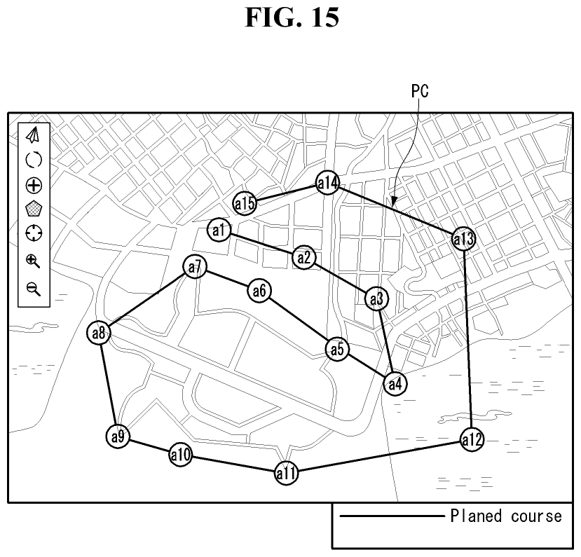

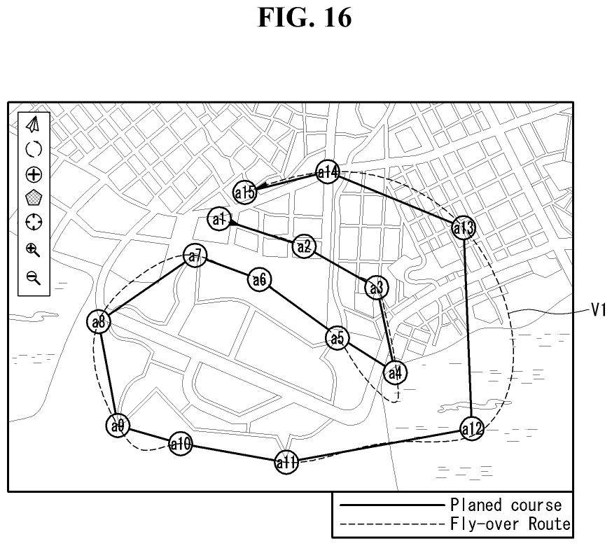

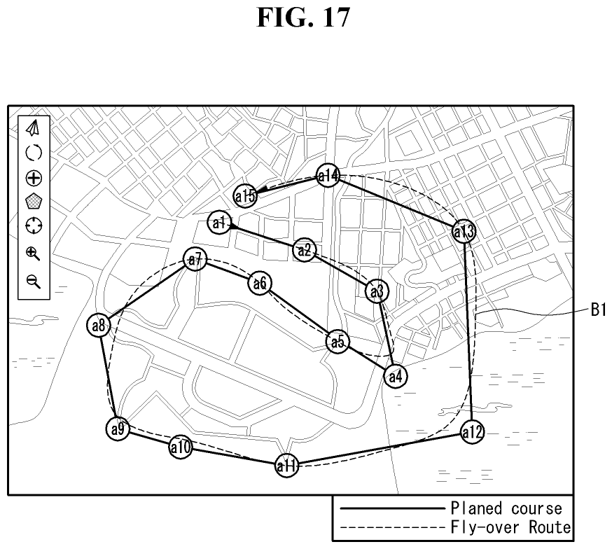

FIG. 14 is a flowchart illustrating a method of controlling a UAV by a device or system according to an embodiment of the disclosure. FIG. 15 is a view illustrating an example of outputting a configured corridor in the form of a web screen by a device or system according to an embodiment of the disclosure. FIG. 16 is a view illustrating an example of outputting a corridor configured as fly-over navigation by a device or system, in the form of a web screen according to an embodiment of the disclosure. FIG. 17 is a view illustrating an example of outputting a corridor configured as fly-by navigation by a device or system, in the form of a web screen according to an embodiment of the disclosure.

Referring to FIG. 14, a device 600 or system 60 according to the disclosure may recognize a UAV, i.e., the drone 100, which it is to control, and be linked or synced with the drone 100 when it starts. Then, the device 600 or system 60 according to the disclosure sequentially configures a plurality of way points, which the UAV 100 will pass through, to the destination (S100). The device 600 or system 60 according to the disclosure connects the configured way points to thereby configure a corridor and gathers topography information including an electronic map and satellite photos for the areas the corridor passes through and the video recorded while the UAV flies. At this time, as the electronic map and satellite photos, the electronic map and satellite photos stored in the database of the device 600 or system 60 may be used, or data for the electronic map and satellite photos may be fetched or gathered from other device, server, or system.

The video recorded by the UAV during flight may be not the video recorded by the UAV 100 directly controlled by the display device 100, but a video recorded by a UAV flying along the same or a similar corridor to the configured corridor may be searched for and gathered by an external network and fetched by the device 600 or system 60. This is why the UAV 100 directly controlled by the device 600 or system 60 according to the disclosure may have no experience of flying along the corridor configured by the device 600 or system 60 and, thus, it may now possess the image data recorded for the corridor.

Thereafter, the device 600 or system 60 machine-learns the topography information including the electronic map and satellite photos for the configuration corridor and the video recorded by the UAV while flying along the corridor or a similar corridor thereto (S110). The device 60 or system 620 machine-learns the topography information including the electronic map and satellite photos and the video recorded by the UAV while flying along the corridor or a similar corridor thereto using the AI processor 620 and a deep-learning model (56 of FIG. 11). In this case, the AI processor 620 and the deep-learning model (56 of FIG. 11) learn the electronic map and satellite photos and/or the video using an image analysis or video analysis method and determine whether there is anything recognized as an obstacle in the electronic map and satellite photos and/or video.

Meanwhile, the device 600 or system 60 determines whether an obstacle is present at each way point and within a predetermined range (e.g., in a range of 150 m or less horizontally and 30 m or less vertically from the way point) from the way point according to the result of machine learning (S120). In this case, upon determining that an obstacle is preset at the way point and within a predetermined range from the way point according to the result of machine learning (S120), the device 600 or system 60 detects and marks the obstacle from the electronic map and satellite photos and/or video, which serve as training data, configures at least one or more way points different from the existing way point in an obstacle-free area, and configures a detour corridor to allow the UAV 100 to fly around the detected obstacle (S130). If the detour corridor is configured, the UAV 100 performs recording while flying along the detour corridor, and the device 600 or system 60 receives the video recorded by the UAV 100 and again machine-learns the video along with the electronic map and satellite photos and determines whether there is an obstacle and determines whether to configure a detour corridor.

Meanwhile, upon determining that there is no obstacle on the corridor in step S120, the device 600 or system 60 calculates the angle formed by at least one three or more sequentially connected way points for all the way points included in the corridor (S140). For example, as shown in FIG. 13(a), the angle formed by three sequentially connected way points wp1, wp2, and wp3 may be calculated (S140).

Thereafter, the device 600 or system 60 may determine whether the calculated angle exceeds a predetermined value and determine whether the UAV 100 flies through all of the at least three or more way points (e.g., wp1, wp2, and wp3 of FIG. 13(a)) (S150). For example, the device 600 or system 60 may calculate the angle formed by the three sequentially connected way points wp1, wp2, and wp3 shown in FIG. 13(a) (S140) and determine whether the calculated angle exceeds the predetermined value (S150). In this case, when the angle formed by the three sequentially connected way points wp1, wp2, and wp3 shown in FIG. 13(a) exceeds 135 degrees, the device 600 or system 60 configures a corridor modified for the UAV 100 to fly over the second way point wp2, among the three sequentially connected way points wp1, wp2, and wp3 and controls the UAV 100 to fly along the modified corridor (S151).

The predetermined value used when the angle formed by the three sequentially connected way points wp1, wp2, and wp3 exceeds the predetermined value may be previously configured by the manager or user. Thus, in the above-described example, the predetermined value of 135 degrees is merely an example. It is preferable that the predetermined value is an obtuse angle.

Meanwhile, when the angle formed by the three sequentially connected way points wp1, wp2, and wp3 is less than the predetermined value, the device 600 or system 60 machine-learns the electronic map and satellite photos and/or the video recorded by the UAV 100 during flight so as to determine whether a landmark is present at each way point and in an area adjacent to the three way points (S160).

Here, each way point and the area adjacent to the three way points means the GPS coordinates of each way point and an adjacent area within a predetermined range, e.g., 150m or less horizontally and 30m or less vertically, from the GPS coordinates. The adjacent area may be configured to a different area by the manager or user.

Meanwhile, upon detecting a landmark from the area adjacent to the three way points as a result of machine-learning the electronic map and satellite photos for each way point and the area adjacent to the three way points and/or the video recorded while the UAV 100 flies (S170), the device 600 or system 60 configures a corridor along which the UAV 100 passes through all of the three sequentially connected way points wp1, wp2, and wp3 (S180). An example of the corridor passing through all of the three sequentially connected way points wp1, wp2, and wp3 may be a corridor along which the UAV flies over the second way point wp2 among the at least three sequentially connected way points wp1, wp2, and wp3 as shown in FIG. 13(b).

In contrast, upon failing to detect a landmark from the area adjacent to the three way points as a result of machine-learning the electronic map and satellite photos for each way point and the area adjacent to the three way points and/or the video recorded while the UAV 100 flies (S170), the device 600 or system 60 configures a corridor along which the UAV 100 passes through two way points of the three sequentially connected way points wp1, wp2, and wp3. In other words, upon failing to recognize a landmark in the area adjacent to the three way points, the device 600 or system 60 may configure a corridor along which the UAV does not fly through, but just pass by, the second way point among the three or more sequentially connected way points wp1, wp2, and wp3 (S190). An example of such a corridor may be a corridor along which the UAV flies by the second way point wp2 among the at least three sequentially connected way points wp1, wp2, and wp3 as shown in FIG. 13(a).

Examples of configuring a corridor along which a UAV is to fly according to the order of FIG. 14 by a device or system according to an embodiment of the disclosure are described below in greater detail with reference to FIGS. 15 to 17. For a better understanding and illustration purposes, it is assumed that the UAV 100 is a drone 100, and the device 600 is the user's mobile device 600.

Referring to FIG. 15, the device 600, i.e., the user's mobile device 600, according to the disclosure, may output a corridor configuration screen in the form of a webpage, as shown in FIG. 15, in the state of having been linked or synced with the UAV, i.e., the drone 100, which the device 600 is to control, as soon as it starts. The webpage may be output via the display unit provided in the mobile device 600 or via the display unit of other terminal 300 connected with the mobile device 600 to be able to perform data communication.

The mobile device 600 sequentially configures a plurality of way points where the drone 100 is to fly as shown in FIG. 15 (S100). FIG. 15 illustrates an example in which 15 way points a1 to a15 are configured from the departure point a1 to the destination point a15 by the mobile device 600. The way points may be configured directly by the user of the mobile device 600, or the device 600 may automatically configure the way points along the corridor recommended by the mobile device 600.

Meanwhile, the mobile device 600 connects the configured way points to configure a corridor and gathers topography information including the electronic map and satellite photos for the areas the corridor passes through. Further, the mobile device 600 may also gather the video recorded by other drone which has previously flown through the areas the corridor passes through. At this time, as the electronic map and satellite photos, the electronic map and satellite photos stored in the database of the mobile device 600 may be used, or the electronic map and satellite photos stored in other device or server may be fetched or gathered.

The video recorded by the other drone during flight need not be the video recorded by the other drone which has flown along the same corridor as the reaction region configured by the mobile device 600, but any video recorded by other drone which has flown along the same or a similar corridor to the corridor configured by the mobile device 600 may be searched for and gathered by an external device and fetched by the mobile device 600. This is why the drone 100 has not yet flow along the corridor configured by the mobile device 600 according to the disclosure and thus lacks image data for the corridor. Thereafter, the mobile device 600 machine-learns the gathered video and the topography information including the electronic map and satellite photos gathered for the configured corridor (S110).

The mobile device 600 machine-learns the topography information including the electronic map and satellite photos gathered using the AI processor 620 and a deep-learning model (56 of FIG. 11) and the gathered video. In this case, the AI processor 620 and the deep-learning model (56 of FIG. 11) learn the electronic map and satellite photos and/or the video using an image analysis or video analysis method and determine whether there is anything recognized as an obstacle in the electronic map and satellite photos and/or video (S120).

For example, the mobile device 600 determines whether an obstacle is present at each way point and within a predetermined range (e.g., in a range of 150m or less horizontally and 30m or less vertically from the way point) from the way point according to the result of machine learning (S120). For example, upon configuring the corridor from a13 to a15, the mobile device 600 may configure the way points so that the UAV may fly from a13 directly to a15 along the corridor. However, in the example shown in FIG. 15, the mobile device 600 has configured the way points to allow the UAV to fly through a14 to a15, rather than flying from a13 directly to a15. In other words, assuming that an obstacle is present between the area configured as a13 and the area configured as 15 to prevent the UAV from flying from a13 directly to a15, the mobile device 600 may image-analyze the electronic map or satellite photos of the area via the AI processor 620, configure a14, and configure a corridor along which the drone 100 flies around the obstacle.

Meanwhile, upon determining that an obstacle is present at the way point and within a predetermined range from the way point according to the result of machine learning (S120), the mobile device 600 may detect and mark the obstacle in the electronic map and satellite photos and/or video which serve as training data. If the detour corridor is configured, the drone 100 performs recording while flying along the detour corridor, and the mobile device 600 receives the video recorded by the UAV 100 and again machine-learns the video along with the electronic map and satellite photos and determines whether there is an obstacle in the area where the drone 100 will fly and determines whether to configure a detour corridor.

Meanwhile, upon determining that there is no obstacle on the corridor in step S120, the mobile device 600 calculates the angle formed by at least one three or more sequentially connected way points for all the way points included in the corridor (S140). For example, as shown in FIG. 15, the angle formed by three sequentially connected way points a11, a12, and a13 may be calculated (S140).

The mobile device 600 may determine whether the angle formed by three way points a3, a4, and a5 is less than a predetermined value (e.g., 135 degrees) and determine whether the drone 100 flies through all of the three way points a3, a4, and a5 (S150). Since the angle formed by the three sequentially connected way points a6, a7, and a8 shown in FIG. 15 exceeds 135 degrees which is the predetermined value preset in the mobile device 600, the mobile device 600 may configure a corridor modified for the drone 100 to fly over the first way point a6 or second way point a7 among the three way points a6, a7, and a8 and control the drone 100 to fly along the modified corridor (S151).

The corridor configured by the mobile device 600 to allow the drone 100 to fly over the way point a6 or a7 may be configured as corridor V1 shown in FIG. 16. Referring to FIG. 16, the three way points a6, a7, and a8 form an obtuse angle in a gentle ‘A’ shape. The mobile device 600 may configure the drone 100 to fly over way point a6 or a7 among the three way points a6, a7, and a8, and the flyover-applied, modified corridor may be shaped as V1. In other words, the corridor may be configured so that the drone 100 approaches a6 from a5 and, after flying through a6, flies a predetermined distance more and then slowly veers to a7.

In this case, a6 and a7 may be observed for a longer time and the drone 100 need not burst for veering from a6 to a7, thus minimizing the battery and/or fuel consumption.

The predetermined value for determining whether the angle is more than, or less than, the predetermined reference may be previously configured by the manager or user, and such configuration may be changed anytime via the mobile device 600. Thus, in the above-described example, the predetermined value of 135 degrees is merely an example. It is preferable that the predetermined value is an obtuse angle.

Meanwhile, when the angle formed by the three sequentially connected way points among the way points shown in FIG. 15 is less than the predetermined value, the mobile device 600 machine-learns the electronic map and satellite photos and/or the video recorded by the drone 100 during flight so as to determine whether a landmark is present at each way point and in an area adjacent to the three way points (S160).

Here, each way point and the area adjacent to the three way points means the GPS coordinates of each way point and an adjacent area within a predetermined range, e.g., 150m or less horizontally and 30m or less vertically, from the GPS coordinates. The configuration of the adjacent area may be modified by the manager or user via the mobile device 600.

Referring to FIG. 15, the three way points a3, a4, and a5 form an acute angle in a sharp ‘v’ shape. The mobile device 600 may previously determine that the drone 100 needs to sharply turn at the way points a3, a4, and a5 and identify whether the target necessary for fulfilling the mission is at the way points a3, a4, and a5. Upon determining that the drone 100 need not perform a special mission, e.g., video recording, while flying through the way points a3, a4, and a5, the mobile device 600 may determine that the drone 100 is required to fly through none of the way points a3, a4, and a5. The mobile device 600 may determine that the drone 100 fly through all of the way points a3, a4, and a5 without sharply turning to thereby minimize the battery or fuel consumption.

To identify whether a target necessary for carrying out a mission is at the way point a3, a4, and a5, the mobile device 600 deep-learns the electronic map and satellite photos for each way point a3, a4, and a5 and an area adjacent to the three way points (e.g., an area within 150m or less horizontally and 150m or less vertically from each of a3, a4, and 5) and/or the video recorded while the drone 100 flies (S160).

Upon detecting a landmark at the area adjacent to the three way points (e.g., an area within 150m or less horizontally and 150m or less vertically from each of a3, a4, and 5) (S170), the mobile device 600 configures a corridor to allow the drone 100 to fly through all of the three sequentially connected way points a3, a4, and a5 (S180). In other words, the mobile device 600 may configure a corridor to allow the drone 100 to fly over the second way point a4 so that the drone 100 may fly through all of the three sequentially connected way points a3, a4, and a5, like the V1 corridor shown in FIG. 16.

The V1 corridor shown in FIG. 16 is described in greater detail. The mobile device 600 allows the drone 100 to approaches a4 from a3 along a gentle curve rather than directly approaching a4 along a straight line course so that the drone 100 is avoided from sharply turning when flying through a4, thereby minimizing the battery and/or fuel consumption. Since the drone 100's turning at a4 takes a little longer, the drone 100 may have a temporal room to be able to more efficiently fulfill a special mission, e.g., recording, on the landmark present at a4.

In contrast, however, when no landmark is detected at the area adjacent to the three way points a3, a4, and a5 as a result of machine-learning the video recorded by the drone 100 during flight and/or the electronic map and satellite photos for the three way points a3, a4, and a5 and the area adjacent to the three way points (S170), the mobile device 600 may determine that the drone 100 need not carry out a special mission, e.g., video recording, while flying through the way points a3, a4, and a5 and configure a corridor to allow the drone 100 to fly through two way points among the three or more sequentially connected way points a3, a4, and a5. In other words, upon failing to recognize the landmark in the area adjacent to the three way points a3, a4, and a5, the mobile device 600 may configure a corridor to allow the drone 100 to fly by, without passing through, the way point a4 among the three sequentially connected way points a3, a4, and a5 (S190). In the example of configuring a corridor, a corridor may be configured along which the drone 100 may fly by the second way point a4 among the three way points a3, a4, and a5 like the corridor B1 shown in FIG. 17.

Although in the above description made in connection with FIGS. 15 to 17, the device 600 or system 60 according to an embodiment of the disclosure configures the fly-by navigation alone or fly-over navigation alone upon configuring a corridor along which the drone 100 is to fly, embodiments of the disclosure are not limited thereto. Rather, the device 600 or system 60 according to an embodiment of the disclosure may gather a diversity of variables that are generated as the drone 100 flies along the way points included in the corridor, performs computation thereon via the AI processor, and determine whether the drone 100 flies over or flies by each way point. Thus, the above-described examples of flying over or flying by at each way point are provided solely for illustration purposes for understanding the core spirit of the disclosure and the spirit of the disclosure is not limited thereto.

A device or system for controlling an UAV according to the disclosure calculates all the angles formed by at least three sequentially connected way points for all the way points included in a corridor automatically configured by the corridor configuration unit 611 and determines whether the UAV 100 flies through all of the three consecutively connected way points depending on whether the calculated angles exceed a predetermined value.

In particular, the AI processor 620 according to the disclosure gathers and machine-learns the topography information including the electronic map and satellite photos for the areas with the corridor configured and the video recorded by other UAV while flying along the same or a similar corridor, analyzes the geographical state for the area with the corridor configured, and provides the analyzed result, as learning result data, to the corridor configuration unit 611. The corridor configuration unit 611 may determine and detect whether a landmark is present at the three consecutive way points and their adjacent area using the learning result data of the AI processor 620.

Upon determining that the angle formed by the at least three consecutive way points is less than a predetermined value and no landmark is present at the at least three way points and their adjacent area, the corridor configuration unit 611 may configure a corridor to allow the drone 100 to fly by the second way point among the at least three way points.

Upon determining that the angle formed by the at least three consecutive way points is less than a predetermined value and a landmark is present at the at least three way points and their adjacent area, the corridor configuration unit 611 may configure a corridor to allow the drone 100 to fly over the second way point among the at least three way points while flying through the at least three way points.

Upon determining that the angle formed by the at least three consecutive way points is more than a predetermined value and no landmark is present in the area adjacent to the at least three way points, the corridor configuration unit 611 may configure a corridor to allow the drone 100 to fly by the second way point among the at least three way points.

Upon determining that the landmark is present at the three way points and their adjacent area regardless of the angle formed by the at least one three consecutive way points, the corridor configuration unit 611 may generate additional way points between the first and third way point among the three way points and configure a corridor to allow the UAV 100 to fly over while flying through the second way point of the three way points and the additional way points. In this case, it is preferable that the corridor configuration unit 611 configures the additional way points around the landmark. The corridor configuration unit 611 may configure the additional way points around the landmark to allow the UAV 100 to efficiently perform the mission of recording the landmark while circling around the landmark for a sufficient time and lead the UAV 100 to the position where a view angle and composition suitable for the UAV 100 to record the landmark may be provided. Such additional way points may be produced via AI processing by the AI processor 620 that has learned the topography information for the landmark.

Further, the AI processor 620 may provide the result of learning the landmark topography information for the locational coordinates, area, and height of the landmark to the corridor configuration unit 611. Upon identifying that the area or height of the landmark is a predetermined value or more, the corridor configuration unit 611 may generate at least one or more additional way points to allow the UAV 100 to perform the mission of recording the landmark and configure a corridor to allow the UAV 100 to fly over the additional way points.

The reference value for identifying that the area or height of the landmark is a predetermined value may be previously set by the user or manager. For example, when the area of the landmark is 10m2 or more, and the height of the landmark is 10m or more, the corridor configuration unit 611 may be configured to generate at least one or more additional way points to allow the UAV 100 to perform the mission of recording the landmark. The reference value may be varied by the user or manager.

When the distance between at least four or more sequentially connected way points among all the way points included in the automatically configured corridor is a predetermined value or less, the corridor configuration unit 611 may calculate a first angle formed by the first, second, and third way points among the at least four or more way points and a second angle formed by the second, third, and fourth way points among the at least four or more way points, determine whether the first angle and the second angle both exceed a predetermined value, and determine whether the UAV is to fly through all of the four way points.

The reference value for the distance between the four or more way points and the reference values for the first angle and the second angle may be previously set by the user or manger. For example, where the four sequentially connected way points are a, b, c, and d, and each distance a-b, b-c, and c-d is less than 10m, the corridor configuration unit 611 may calculate the first angle formed by the way points a-b-c and the second angle formed by the way points b-c-d. If the first angle and the second angle each are less than 120 degrees, the corridor configuration unit 611 may configure the UAV to fly by, i.e., pass by, the way points b and c among the four way points a, b, c, and d.

As another example, it is assumed that where the four sequentially connected way points are a, b, c, and d, and each distance a-b, b-c, and c-d is 20m, the corridor configuration unit 611 is configured to calculate the first angle formed by the way points a-b-c and the second angle formed by the way points b-c-d. In this case, the corridor configuration unit 611 may calculate the first angle formed by the way points a-b-c and the second angle formed by the way points b-c-d, and the first angle and the second angle are assumed to both exceed 135 degrees. In this case, the corridor configuration unit 611 may determine that the interval between the four connected way points is 20m and is thus wide enough and, since the first angle formed by the way points a-b-c and the second angle formed by the way points b-c-d are not sharp but gentle, the corridor configuration unit 611 may determine that flying through all of the four consecutively connected corridor widths would be more smooth flight. However, to prevent an increase in the battery and/or fuel consumption as the UAV 100 sharply veer at each way point a to d, the corridor configuration unit 611 may configure a corridor to allow the UAV 100 to fly through all of the way points a to d, but fly over each way point a, b, c, and d, within a predetermined distance, e.g., 1m, or more or less.

For the case where the device 600 or system 60 according to the disclosure configures a corridor for, and controls, at least two or more UAVs, the corridor configuration unit 611 may configure a corridor for each of the plurality of UAVs. In this case, to allow at least two or more UAVs to swarm, the corridor configuration unit 611 may configure a corridor for each UAV based on a corridor for pattern flight pre-stored in the device 600 or system 60 or a corridor for swarming flight generated according to the data resultant from learning the swarming flight pattern by the AI processor.

For example, where the at least two or more UAVs include a first UAV and a second UAV 100, the corridor configuration unit 611 may configure 10 way points to allow the first UAV to circle clockwise. The corridor configuration unit 611 may configure other 10 way points for the second UAV, which is to perform swarming flight with the first UAV, to automatically circle counterclockwise. In other words, the corridor configuration unit 611 may configure a first corridor for the first UAV and may automatically configure a second corridor, which is symmetrical with the first corridor, for the second UAV.

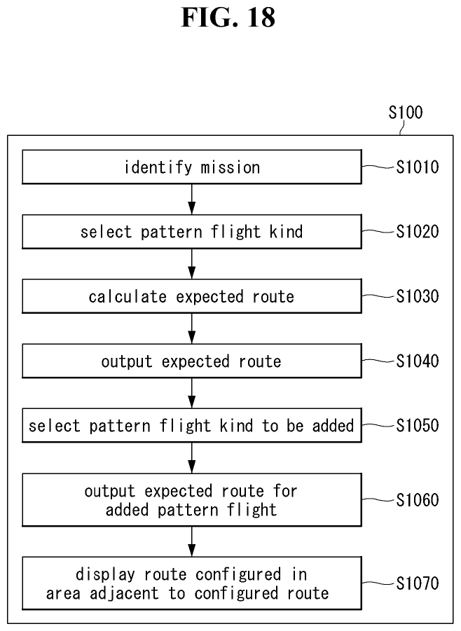

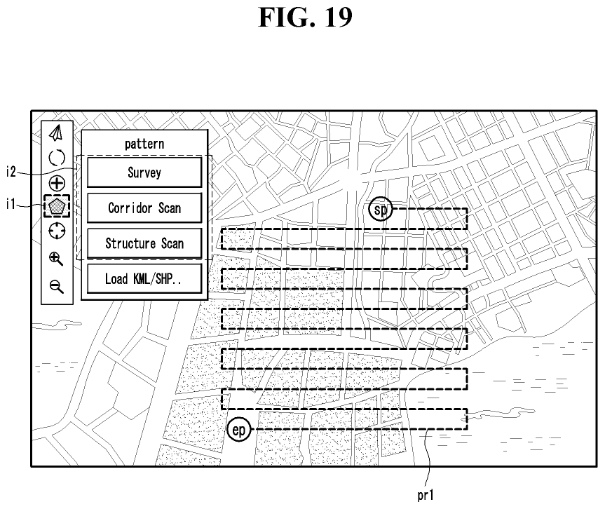

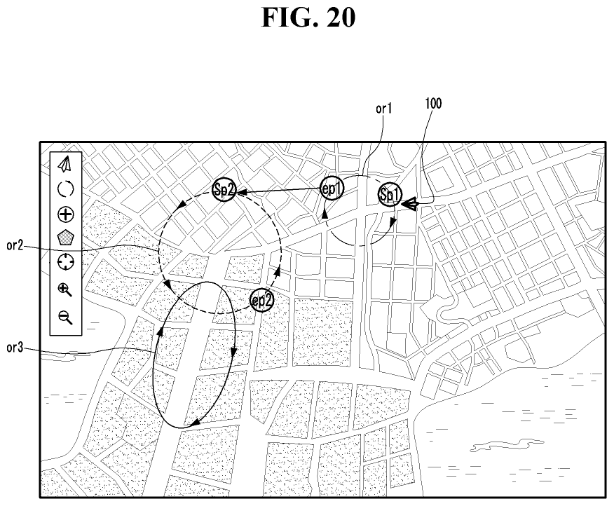

A method of configuring a pattern corridor of a UAV by a device or system according to an embodiment of the disclosure is described below with reference to FIGS. 18 to 20. FIG. 18 is a flowchart illustrating a method of configuring a pattern corridor for a UAV by a device or system according to an embodiment of the disclosure. FIG. 19 is a view illustrating an example of outputting the pattern corridor configured according to the flowchart of FIG. 18, as a web screen. FIG. 20 is a view illustrating an example of outputting a newly configured pattern corridor, other than the existing pattern corridor, by a device or system according to an embodiment of the disclosure. Referring to FIG. 14, a device 600 or system 60 according to the disclosure may recognize a UAV, i.e., the drone 100, which it is to control, and be linked or synced with the drone 100 when it starts.

Then, the step S100 of configuring a plurality of way points where the UAV 100 is to sequentially fly may further include the step S1010 of identifying a mission configured by the user by the device 600 or system 60 as shown in FIG. 18, the step S1020 of selecting a pattern flight kind corresponding to the configured mission, the step S1030 of calculating an expected route along which the UAV 100 is to fly depending on the selected pattern flight kind, and the step S1040 of outputting the calculated expected route via the device 600 or the terminal 300.

The kind of pattern flight which may be configured by the device 600 or system 60 may be a conventionally known pattern flight such as orbit, survey, corridor, scan, or structure scan pattern. The device 600 or system 60 according to the disclosure displays such pattern flight item as a first icon i1, which is a graphic user interface (GUI), on the web screen of FIG. 19 and, if the user clicks on the first icon i1, the above-described various pattern flights are displayed in the form of a group button i2 to allow the user to select a needed pattern flight.

If the user selects the pattern flight, the device 600 or system 60 according to the disclosure displays an expected route for the pattern flight as a route pr1 shown in FIG. 19. For example, if the user selects Survey among the pattern flights included in the group button i2, a pattern corridor pr1 with a start point sp and an end point ep is output on the web screen as shown in FIG. 19. The user may change the position of the start point sp and the end point ep on the web screen and may adjust the whole length, section length, or inter-section route interval of the route pr1.

As shown in FIG. 18, the step S100 of configuring a plurality of way points where the UAV is to sequentially fly may further include, after step S1040, the step S1050 of selecting the kind of pattern flight to be added other than the existing pattern flights, the step S1060 of outputting an expected route for the added pattern flight, and the step S1070 of outputting the additionally configured route along with a route configured in an adjacent area.

In other words, if the user sets to perform a pattern flight for the first time, and the drone 100 starts to fly along the configured pattern corridor, the device 600 or system 60 may inquire the user whether there is a pattern flight to be added a predetermined time after the pattern flight. If the user selects a kind of pattern flight to be added other than the existing pattern flight kinds (S1050), the expected route therefor may be output on the web screen as shown in FIG. 20.

FIG. 20 is a view illustrating an example of outputting on the web screen when the user configures an additional pattern flight, wherein the user previously configures the first pattern flight, and the route of the first pattern flight is displayed as or1 on the web screen. The route or1 of the first pattern flight includes a start point sp1 and an end point ep1. The device 600 or system 60 according to the disclosure may inquire the user whether to configure an additional pattern flight while the drone 100 flies along the route or1 of the first pattern flight and before the drone 100 arrives at the end point ep1.

If the user desires to add a second pattern flight and configures a trajectory flight with a larger radius than the route or1 of the existing first pattern flight as an additional pattern flight (S1050), the device 600 or system 60 according to the disclosure displays the route or2 of the second pattern flight in addition to the existing route or1 of the first pattern flight (S1060). It may be identified from FIG. 20 that the route or2 of the second pattern flight includes a start point sp2 and an end point ep2, and the start point sp2 and the end point ep2 are connected together via a transition way.

Further, the route or1 of the first pattern flight and the route or2 of the second pattern flight may overlap the flight route of other UAV flying in the route-configured airspace. Thus, where there is other UAV in a nearby airspace than the drone 100 directly controlled by the device 600 or system 60 according to the disclosure, the device 600 or system 60 may gather the routes configured therefor and display them along with the route or3 of the other UAV as shown in FIG. 20 (1070). Thus, the user may prevent collision with other UAV in the step of configuring a flight route upon flight planning using the device 600 or system 60 according to the disclosure.

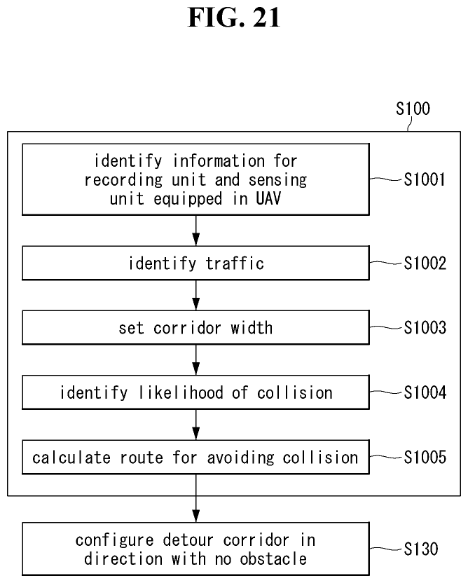

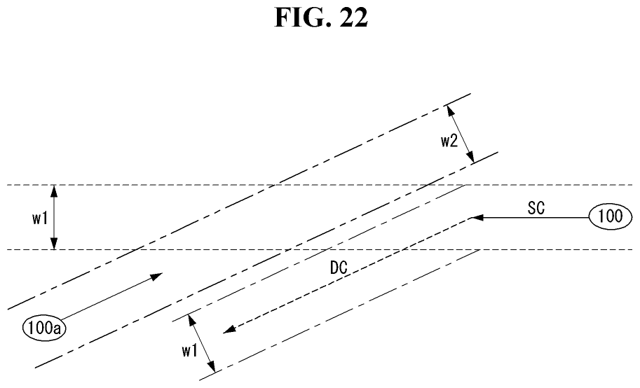

A method of configuring a corridor width for a UAV by a device or system according to the disclosure is described below with reference to FIGS. 21 and 22. FIG. 21 is a flowchart illustrating a method of configuring a corridor width for a UAV by a device or system according to the disclosure. FIG. 22 is a view illustrating an example of avoiding collision between a UAV and another UAV based on the corridor width configured according to the flowchart of FIG. 21. Referring to FIG. 14, a device 600 or system 60 according to the disclosure may recognize a UAV, i.e., the drone 100, which it is to control, and be linked or synced with the drone 100 when it starts.

Thereafter, the step S100 of configuring a plurality of way points where the UAV 100 is to sequentially fly may include the step S1001 of identifying information for the sensing unit 130 and the recording unit 190 equipped in the UAV, the step S1002 of identifying the traffic in the airspace where the UAV is to fly, the step S1003 of configuring a corridor width for the UAV, the step S1004 of identifying the likelihood of collision with other UAV, and the step S1005 of calculating a route to allow the UAV to avoid collision with the other UAV as shown in FIG. 21.

The device 600 or system 60 according to the disclosure identifies the information for the sensing unit 130 and the recording unit 190 equipped in the UAV in S100, identifies hardware information for a anti-collision sensor included in the sensing unit 130, and identifies hardware information, such as the magnification, view angle, or pixel of the camera and the camera gimbal included in the recording unit 190 (S1001). Thereafter, the device 600 or system 60 identifies the traffic of UAVs flying in the airspace where the UAV is to fly while simultaneously configuring way points (S1002).

The device 600 or system 60 configures a corridor width which is the minimum interval that should be kept between the UAV 100 and another UAV in the context where the UAV 100 runs into the other UAV, i.e., head-on context, based on the hardware information for the camera, camera gimbal, and anti-collision sensor identified in step S1001. The minimum value of the corridor width may be set to differ depending on the hardware performance of the anti-collision sensor included in the UAV 100.

For example, according to RNP-10, which is the required navigation performance (RNP) specifying the anti-collision performance and traffic separation interval for aircrafts, an aircraft is required to fly within an error of 10 nm from the center of the corridor during 95% of the total flight time of the aircraft. With this code applied to the UAV, the device 600 or system 60 may configure the UAV to fly within an error of 1m from the center of the corridor.

Referring to FIG. 22, the device 600 or system 60 according to the disclosure may configure a corridor width to allow the UAV 100 to fly within a range of a first corridor width w1 from the center line of the corridor while flying along the configured corridor (sc). Here, the first corridor width w1 may be set to, e.g., 1m, and the user may change the configuration anytime via the device 600 or system 60.

Where the UAV 100 and another UAV 100a are about to collide head-on, the device 600 or system 60 according to the disclosure may configure a detour corridor (dc) for the UAV 100 considering a first corridor width w1 configured for the UAV 100 and the second corridor width w2 configured for the other UAV 100a, so that the first corridor width w1 does not overlap the second corridor width w2. Thus, the device 600 or system 60 according to the disclosure may prevent collision between the UAVs.

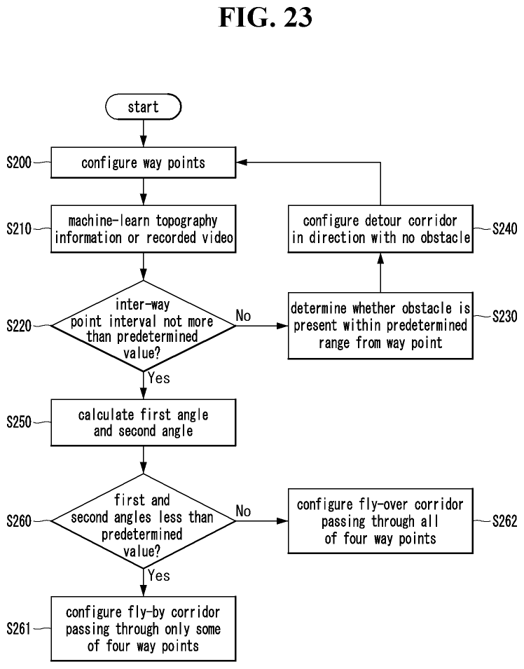

The device 600 or system 60 according to the disclosure may control a UAV as shown in the flowchart of FIG. 23. Referring to FIG. 23, a device 600 or system 60 according to the disclosure may recognize a UAV, i.e., the drone 100, which it is to control, and be linked or synced with the drone 100 when it starts.

Then, the device 600 or system 60 according to the disclosure sequentially configures a plurality of way points, which the UAV 100 will pass through, to the destination (S200). The device 600 or system 60 according to the disclosure connects the configured way points to thereby configure a corridor and gathers topography information including an electronic map and satellite photos for the areas the corridor passes through and the video recorded while the UAV flies. At this time, as the electronic map and satellite photos, the electronic map and satellite photos stored in the database of the device 600 or system 60 may be used, or data for the electronic map and satellite photos may be fetched or gathered from other device, server, or system.

The video recorded by the UAV during flight may be not the video recorded by the UAV 100 directly controlled by the display device 100, but a video recorded by a UAV flying along the same or a similar corridor to the configured corridor may be searched for and gathered by an external network and fetched by the device 600 or system 60. This is why the UAV 100 directly controlled by the device 600 or system 60 according to the disclosure may have no experience of flying along the corridor configured by the device 600 or system 60 and, thus, it may now possess the image data recorded for the corridor. Thereafter, the device 600 or system 60 machine-learns the topography information including the electronic map and satellite photos for the configuration corridor and the video recorded by the UAV while flying along the corridor or a similar corridor thereto (S210).

The device 60 or system 620 machine-learns the topography information including the electronic map and satellite photos and the video recorded by the UAV while flying along the corridor or a similar corridor thereto using the AI processor 620 and a deep-learning model (56 of FIG. 11). In this case, the AI processor 620 and the deep-learning model (56 of FIG. 11) learn the electronic map and satellite photos and/or the video using an image analysis or video analysis method and determine whether there is anything recognized as an obstacle in the electronic map and satellite photos and/or video. Thereafter, the corridor configuration unit 611 determines whether the distance between at least sequentially connected four or more way points among all of the way points included in the automatically configuration corridor is a predetermined value or less (S220).

If the distance between the at least four or more way points exceeds the predetermined value (S220), the device 600 or system 60 according to the disclosure determines whether an obstacle is present at each way point and within a predetermined range (e.g., in a range of 150m or less horizontally and 30m or less vertically from the way point) from the way point according to the result of machine learning (S230).

In this case, upon determining that an obstacle is present at the way point and within a predetermined range from the way point according to the result of machine learning (S230), the device 600 or system 60 detects and marks the obstacle from the electronic map and satellite photos and/or video, which serve as training data, configures at least one or more way points different from the existing way point in an obstacle-free area, and configures a detour corridor to allow the UAV 100 to fly around the detected obstacle (S240). If the detour corridor is configured, the UAV 100 performs recording while flying along the detour corridor, and the device 600 or system 60 receives the video recorded by the UAV 100 and again machine-learns the video along with the electronic map and satellite photos and determines whether there is an obstacle and determines whether to configure a detour corridor.

Meanwhile, upon determining that there is no obstacle on the corridor in step S220, the device 600 or system 60 calculates the angle formed by at least multiple sequentially connected way points for all the way points included in the corridor (S250). For example, as shown in FIG. 13(a), the angle formed by three sequentially connected way points wp1, wp2, and wp3 may be calculated (S250). As shown in FIG. 15, two angles (a first angle and a second angle) formed by the four sequentially connected way points at a2, a3, and a4 may be calculated (S250).

In particular, when the distance between at least four or more sequentially connected way points among all the way points included in the automatically configured corridor is a predetermined value or less in step S220, the corridor configuration unit 611 may calculate a first angle formed by the first, second, and third way points among the at least four or more way points and a second angle formed by the second, third, and fourth way points among the at least four or more way points (S250).

The corridor configuration unit 611 determines whether the first angle and the second angle both exceed a predetermined value (S260) and, when the first angle and the second angle are less than the predetermined value, configure a fly-by corridor along which the UAV flies through only some way points among the four way points (S261).

For example, where the four sequentially connected way points are a, b, c, and d, and each distance a-b, b-c, and c-d is less than 10m (S220), the corridor configuration unit 611 may calculate the first angle formed by the way points a-b-c and the second angle formed by the way points b-c-d (S250). If the first angle and the second angle each are less than 120 degrees (S260), the corridor configuration unit 611 may configure the UAV to fly by, i.e., pass by, the way points b and c among the four way points a, b, c, and d (S261). The reference value for the distance between the four or more way points and the reference values for the first angle and the second angle may be previously set by the user or manger.

However, the corridor configuration unit 611 determines whether the first angle and the second angle both exceed a predetermined value (S260) and, when the first angle and the second angle exceed the predetermined value, configure a fly-over corridor along which the UAV flies through all of the four way points (S262).

As an example, it is assumed that where the four sequentially connected way points are a, b, c, and d, and each distance a-b, b-c, and c-d is 20m (S220), the corridor configuration unit 611 is configured to calculate the first angle formed by the way points a-b-c and the second angle formed by the way points b-c-d. In this case, the corridor configuration unit 611 may calculate the first angle formed by the way points a-b-c and the second angle formed by the way points b-c-d (S250), and the first angle and the second angle are assumed to both exceed 135 degrees (S260). In this case, the corridor configuration unit 611 may determine that the interval between the four connected way points is 20m and is thus wide enough and, since the first angle formed by the way points a-b-c and the second angle formed by the way points b-c-d are not sharp but gentle, the corridor configuration unit 611 may determine that flying through all of the four consecutively connected corridor widths would be more smooth flight. However, to prevent an increase in the battery and/or fuel consumption as the UAV 100 sharply veer at each way point a to d, the corridor configuration unit 611 may configure a corridor to allow the UAV 100 to fly through all of the way points a to d, but fly over each way point a, b, c, and d, within a predetermined distance, e.g., 1m, or more or less (S262).

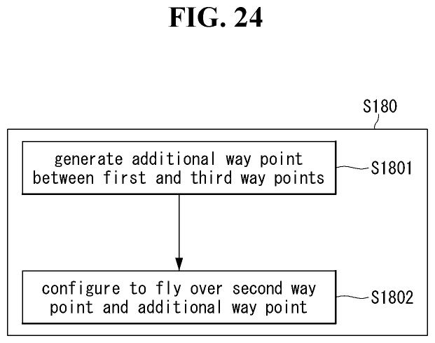

The device 600 or system 60 according to the disclosure may control the UAV to fly around the landmark according to the flowchart of FIG. 24. Referring to FIG. 24, in step S180, the corridor configuration unit 611 configures the UAV 100 to fly over the pre-configured way points around the landmark to allow the UAV 100 on duty for recording to record the landmark for a longer time in a better view angle and composition (S180).

In this case, the corridor configuration unit 611 may configure an additional way point around the landmark to maximize the time during which the UAV 100 on duty for recording the landmark records the landmark. The corridor configuration unit 611 may configure an additional way point to allow the UAV 100 to reach the position where the landmark may be recorded in a better view angle or composition, based on the result of machine learning on the topography information for the landmark by the AI processor 620.

Referring to FIG. 24, the corridor configuration unit 611 may generate additional way points between the first and third way point other than the second way point among the pre-configured three way points (S1801) and configure a corridor to allow the UAV 100 to fly over while flying through the second way point and the additional way points (S1802). In this case, since the additional way points are generated and added in the context where the pre-configured way points are flown over, with the presence of the landmark identified, the corridor configuration unit 611 may control the UAV 100 to fly over without considering the angle formed by the three way points.

For example, the process of generating an additional way point by the corridor configuration unit 611 for the way points a7, a8, and a9 shown in FIG. 15 is described. Referring to FIG. 15, the AI processor 620 may generate learning result data indicating that the way points a7, a8, and a9 are landforms shaped as the head and arms of a turtle based on the result of machine learning on the topography information for the landmark. The AI processor 620 may transmit the learning result data to the corridor configuration unit 611. The corridor configuration unit 611 may allow the UAV 100 to fly over at each of the way points a7, a8, and a9 while flying through all of the way points a7, a8, and a9, thereby increasing the time when the UAV 100 stays in the air at the way points a7, a8, and a9. The corridor configuration unit 611 may calculate the position where the UAV 100 may obtain the optimal view angle and/or composition for the landmark at the way points a7, a8, and a9 and their nearby area, based on the result of machine learning on the topography information for the landmark by the AI processor 620.

The corridor configuration unit 611 may generate additional way points where the UAV 100 may fly over, from the way point a7 through a8 to a9 and dispose them along the corridor from a7 through a8 to a9. The additional way points generated by the corridor configuration unit 611 are preferably configured as way points that do not significantly interfere with the pre-configured corridor from a7 through a8 to a9.

The above-described embodiments of the disclosure may be implemented in code that a computer may read out of a recording medium. The computer-readable recording medium includes all types of recording devices storing data readable by a computer system. Examples of the computer-readable recording medium include hard disk drives (HDDs), solid state disks (SSDs), silicon disk drives (SDDs), read-only memories (ROMs), random access memories (RAMs), CD-ROMs, magnetic tapes, floppy disks, or optical data storage devices, or carrier wave-type implementations (e.g., transmissions over the Internet). Thus, the above description should be interpreted not as limiting in all aspects but as exemplary. The scope of the disclosure should be determined by reasonable interpretations of the appended claims and all equivalents of the disclosure belong to the scope of the disclosure.

The disclosure aims to address the foregoing issues and/or needs. According to the disclosure, there is provided a device, system, and method for controlling a UAV, which, when a corridor is configured to allow the UAV to fly through way points where a significant variation in azimuth occurs, allows the UAV to fly through the way points by fly-by and/or fly-over navigation.

According to the disclosure, there is provided a device, system, and method for controlling a UAV, which, upon detecting an obstacle around a corridor along which the UAV is to fly, automatically configures a detour corridor along which the UAV may avoid the obstacle. According to the disclosure, there is provided a device, system, and method for controlling a UAV, which, when an identifiable landmark and/or mark is present around a corridor along which the UAV is to fly, provides the optimal corridor along which the UAV may fly through the landmark and/or mark by deep-learning satellite photos or video for the landmark and/or mark and the corridor.

According to an embodiment of the disclosure, a device capable of controlling at least one or more unmanned aerial vehicles (UAVs) comprises a first controller generating a control signal for controlling a flight of the UAV and configuring a corridor along which the UAV is to fly, a first communication unit capable of communicating with the UAV and transmitting the control signal and the corridor to the UAV and an AI processor machine-learning topography information including an electronic map and satellite photos for areas which the corridor passes through and a video recorded while the UAV flies along the corridor and determining whether an obstacle or landmark is present on the corridor, wherein the first controller configures a detour corridor to allow the UAV to avoid the obstacle present on the corridor according to learning result data from the AI processor and calculates a variation in azimuth indicating a flight direction of the UAV at, at least one or more, way points included in the corridor and determines whether the UAV flies through the way points depending on the variation in azimuth.

The first controller may include a corridor configuration unit configuring the corridor and a mission configuration unit configuring an operation and function required to be performed by the UAV at the way point or while flying along the corridor. The corridor configuration unit may calculate an angle formed by at least three sequentially connected way points and determine whether the UAV flies through all of the three way points depending on whether the angle exceeds a predetermined value.

The corridor configuration unit may determine and detect whether a landmark is present in an area near the at least three way points based on the learning result data from the AI processor and the angle formed by the at least three way points. Upon determining that the angle formed by the at least three way points is less than the predetermined value and that the landmark is not present at the at least three way points and the nearby area, the corridor configuration unit may configure a corridor to allow the UAV to fly by a second way point among the at least three or more way points.

The corridor configuration unit, upon determining that the angle formed by the at least three way points is less than the predetermined value and that the landmark is present at the at least three way points and the nearby area, may configure a corridor to allow the UAV to fly over a second way point among the at least three or more way points while passing through all of the at least three or more way points.

The corridor configuration unit may generate additional way points between a first way point and a third way point among the at least three way points and configure a corridor to allow the UAV to fly over while passing through the second way point and the additional way points.

Upon determining that the angle formed by the at least three way points exceeds the predetermined angle and that the landmark is not present in the area near the at least three way points based on the learning result data from the AI processor, the corridor configuration unit may configure a corridor to allow the UAV to fly by a second way point among the at least three way points.

Upon determining that the angle formed by the at least three way points exceeds the predetermined angle and that the landmark is present in the area near the at least three way points based on the learning result data from the AI processor, the corridor configuration unit may configure a corridor to allow the UAV to fly over a second way point among the at least three way points.

The corridor configuration unit may generate additional way points between a first way point and a third way point among the at least three way points and configure a corridor to allow the UAV to fly over while passing through the second way point and the additional way points.

The AI processor may provide a result of learning landmark topography information for positional coordinates, area, and height of the landmark to the corridor configuration unit. The corridor configuration unit may, upon identifying that the area or height of the landmark is a predetermined value or more, generate at least one or more additional way points where the UAV may perform a recording mission on the landmark and configure a corridor to allow the UAV to fly over the additional way points.

The corridor configuration unit may, when a distance between at least four or more sequentially connected way points among at least one or more way points included in the corridor is a predetermined value or less, calculate a first angle formed by a first, second, and third way point among the at least four or more way points and a second angle formed by the second, third, and fourth way points among the at least four or more way points, determine whether the first angle and the second angle both exceed a predetermined value, and determine whether the UAV is to fly through all of the four way points.

The corridor configuration unit may configure a corridor for swarming flight generated according to the learning result data from the AI processor or a corridor for pattern flight previously stored in each of at least two or more UAVs to allow the at least two or more UAVs to perform the swarming flight, and configure a first corridor for a first UAV among the at least two or more UAVs and automatically configures a second corridor symmetrical with the first corridor for a second UAV among the at least two or more UAVs.

Upon configuring the corridor, the corridor configuration unit may configure the corridor including an inter-aircraft corridor width to allow the UAV in flight to fly a predetermined distance away from another UAV, based on the learning result data from the AI processor and aircraft data including location, speed, altitude, and orientation information for the UAV, and information obtained by sensors equipped in the UAV.

According to an embodiment of the disclosure, a system comprises a UAV and a device capable of controlling the UAV. The UAV transmits image data recorded while flying and aircraft data including location, speed, altitude, and orientation information for the UAV to the device. The device includes a first controller generating a control signal for controlling a flight of the UAV and configuring a corridor along which the UAV is to fly, a first communication unit capable of communicating with the UAV and transmitting the control signal and the corridor to the UAV, and an AI processor machine-learning topography information including an electronic map and satellite photos for areas which the corridor passes through and a video recorded while the UAV flies along the corridor and determining whether an obstacle or landmark is present on the corridor. The first controller configures a detour corridor to allow the UAV to avoid the obstacle present on the corridor according to learning result data from the AI processor and calculates a variation in azimuth indicating a flight direction of the UAV at, at least one or more, way points included in the corridor and determines whether the UAV flies through the way points depending on the variation in azimuth.

The first controller may include a corridor configuration unit configuring the corridor and a mission configuration unit configuring an operation and function required to be performed by the UAV at the way point or while flying along the corridor. The corridor configuration unit determines whether the UAV flies through all of at least three sequentially connected way points, depending on whether an angle formed by the at least three way points exceeds a predetermined value or whether a landmark is present in an area near the at least three way points based on the learning result data from the AI processor.

The corridor configuration unit, upon determining that the angle formed by the at least three way points is less than the predetermined value and that the landmark is not present at the at least three way points and the nearby area, may configure a corridor to allow the UAV to fly by a second way point among the at least three or more way points and, upon determining that the angle formed by the at least three way points is less than the predetermined value and that the landmark is present at the at least three way points and the nearby area, configure a corridor to allow the UAV to fly over a second way point among the at least three or more way points while passing through all of the at least three or more way points.

The corridor configuration unit, upon determining that the angle formed by the at least three way points exceeds the predetermined angle and that the landmark is not present in the area near the at least three way points based on the learning result data from the AI processor, may configure a corridor to allow the UAV to fly by a second way point among the at least three way points and, upon determining that the angle formed by the at least three way points exceeds the predetermined angle and that the landmark is present in the area near the at least three way points based on the learning result data from the AI processor, configure a corridor to allow the UAV to fly over a second way point among the at least three way points.

Upon configuring the corridor, the corridor configuration unit may configure the corridor including an inter-aircraft corridor width to allow the UAV in flight to fly a predetermined distance away from another UAV, based on the learning result data from the AI processor and aircraft data including location, speed, altitude, and orientation information for the UAV, and information obtained by sensors equipped in the UAV.

According to another embodiment of the disclosure, a method capable of controlling a UAV using a device or a system comprises configuring a plurality of way points where the UAV is to sequentially fly, machine-learning topography information including an electronic map and satellite photos for areas which a corridor passes through or a video recorded while the UAV flies, determining whether an obstacle is present at each way point and within a predetermined range from the way point according to a result of the machine learning, upon determining that the obstacle is present, detecting the obstacle, configuring at least one or more other way points in an area where the obstacle is not present, and configures a detour corridor along which the UAV may avoid the obstacle, calculating an angle formed by at least three or more sequentially connected way points, and determining whether the UAV is to fly through all of the at least three or more way points depending on the calculated angle.

Determining whether the UAV is to fly through all of the at least three or more way points depending on the calculated angle may include determining whether the landmark is present at the at least three or more way points and their respective nearby areas. Determining whether the landmark is present at the at least three or more way points and their respective nearby areas may include, upon determining that the angle formed by the at least three way points, calculated in calculating the angle formed by the at least three or more sequentially connected way points, is less than the predetermined value and that the landmark is not present at the at least three way points and the nearby area, configuring a corridor to allow the UAV to fly by a second way point among the at least three or more way points and, upon determining that the angle formed by the at least three way points, calculated in calculating the angle formed by the at least three or more sequentially connected way points, is less than the predetermined value and that the landmark is present at the at least three way points and the nearby area, configuring a corridor to allow the UAV to fly over the second way point among the at least three or more way points.

Determining whether the landmark is present at the at least three or more way points and their respective nearby areas may include, upon determining that the angle formed by the at least three way points, calculated in calculating the angle formed by the at least three or more sequentially connected way points, exceeds the predetermined angle and that the landmark is not present in the area near the at least three way points based on the learning result data from the AI processor, configuring a corridor to allow the UAV to fly by a second way point among the at least three way points and, upon determining that the angle formed by the at least three way points, calculated in calculating the angle formed by the at least three or more sequentially connected way points, exceeds the predetermined angle and that the landmark is present in the area near the at least three way points based on the learning result data from the AI processor, configuring a corridor to allow the UAV to fly over the second way point among the at least three way points.

Determining whether the landmark is present at the at least three or more way points and their respective nearby areas may include machine-learning topography information including an electronic map and satellite photos for areas which the at least three or more way points are configured or a video recorded while the UAV flies and determining whether the landmark is present within a predetermined range from each of the at least three or more way points, based on a result of the machine learning.

Configuring the plurality of way points where the UAV is to sequentially fly may include gathering aircraft data including hardware information for a camera included in a recording unit or sensors equipped in the UAV, identifying traffic of an airspace or an area where the way points are to be configured, and configuring an inter-aircraft corridor width to allow the UAV to fly, a predetermined distance away from another UAV. According to the disclosure, the device, system, and method capable of controlling a UAV may automatically configure a corridor capable of minimizing battery and/or fuel consumption, thus increasing the overall flight time of the UAV.

According to the disclosure, the device, system, and method capable of controlling a UAV may use various kinds of navigation, which are adopted for fixed wing aircrafts, when the UAV veers at way points where a significant variation in azimuth occurs, thereby minimizing the battery and/or fuel consumption of the UAV. According to the disclosure, the device, system, and method capable of controlling a UAV analyzes satellite photos or video for a landmark and corridor and controls the UAV to fly stable depending on the landform.

According to the disclosure, the device, system, and method capable of controlling a UAV controls the UAV to be able to specifically configure a mission that the UAV is to fulfill at way points. According to the disclosure, the device, system, and method capable of controlling a UAV may previously configure an inter-corridor width, preventing collision between the UAV and another UAV.

It will be understood that when an element or layer is referred to as being “on” another element or layer, the element or layer can be directly on another element or layer or intervening elements or layers. In contrast, when an element is referred to as being “directly on” another element or layer, there are no intervening elements or layers present. As used herein, the term “and/or” includes any and all combinations of one or more of the associated listed items.

It will be understood that, although the terms first, second, third, etc., may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section could be termed a second element, component, region, layer or section without departing from the teachings of the present invention.

Spatially relative terms, such as “lower”, “upper” and the like, may be used herein for ease of description to describe the relationship of one element or feature to another element(s) or feature(s) as illustrated in the figures. It will be understood that the spatially relative terms are intended to encompass different orientations of the device in use or operation, in addition to the orientation depicted in the figures. For example, if the device in the figures is turned over, elements described as “lower” relative to other elements or features would then be oriented “upper” relative to the other elements or features. Thus, the exemplary term “lower” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Embodiments of the disclosure are described herein with reference to cross-section illustrations that are schematic illustrations of idealized embodiments (and intermediate structures) of the disclosure. As such, variations from the shapes of the illustrations as a result, for example, of manufacturing techniques and/or tolerances, are to be expected. Thus, embodiments of the disclosure should not be construed as limited to the particular shapes of regions illustrated herein but are to include deviations in shapes that result, for example, from manufacturing.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Any reference in this specification to “one embodiment,” “an embodiment,” “example embodiment,” etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A device to control at least one unmanned aerial vehicle (UAV), the device comprising
a communication interface configured to exchange of data with the UAV; and
a controller configured to:
determine a flight path for the UAV;
generate a control signal for controlling flight of the UAV along the flight path; and
manage the communication interface to transmit the control signal to the UAV,
wherein the controller performs machine-learning on topography information including at least one of an electronic map, a satellite photo, or at least one image captured while the UAV flies along the flight path to determine when an obstacle is present along the flight path, and modifies the flight path such that the UAV avoids the obstacle.

2. The device of claim 1, wherein controller calculates a variation in azimuth indicating a flight direction of the UAV at one or more way points along the flight path and determines whether the UAV flies through the one or more way points depending on the variation in azimuth.

3. The device of claim 1, wherein the controller calculates an angle formed by at least three sequential way points along the flight path, and determines whether the UAV flies through the at least three way points based on whether the angle exceeds a predetermined value.

4. The device of claim 3, wherein the controller detects whether a landmark is present in an area near the at least three way points based on performing machine-learning on the topography information and the angle formed by the at least three way points.

5. The device of claim 4, wherein the controller, upon determining that the angle formed by the at least three way points is less than the predetermined value and that the landmark is not present at the area near the at least three way points, determines the flight path such that the UAV flies by a second way point among the at least three way points.

6. The device of claim 4, wherein the controller, upon determining that the angle formed by the at least three way points is less than the predetermined value and that the landmark is present at the area near the at least three way points, determines the flight path such that the UAV flies over a second way point among the at least three or more way points.

7. The device of claim 6, wherein the controller determines at least one additional way point between a first way point and a third way point among the at least three way points, and determines the flight path such that the UAV flies over the at least one additional way point.

8. The device of claim 4, wherein the controller, upon determining that the angle formed by the at least three way points is not less than the predetermined value and that the landmark is not present in the area near the at least three way points, determines the flight path such that the UAV flies by a second way point among the at least three way points.

9. The device of claim 4, wherein the controller, upon determining that the angle formed by the at least three way points in not less than the predetermined value and that the landmark is present in the area near the at least three way points, determines the flight path such that the UAV flies over a second way point among the at least three way points.

10. The device of claim 9, wherein the controller determines additional way points between a first way point and a third way point among the at least three way points and determines the flight path such that the UAV flies over the additional way points.

11. The device of claim 4, wherein the controller:
determines an area and a height of the landmark, and
when the area is equal to or greater than a particular area or the height of the landmark is equal to or greater than a particular height, determines one or more additional way points and determines the flight path such that the UAV flies over the additional way points and captures information regarding the landmark.

12. The device of claim 1, wherein the controller, when a distance between at least four or more sequential way points along the flight path is less than or equal to a particular distance:
calculates a first angle formed by a first, second, and third way point among the at least four or more way points and a second angle formed by the second, third, and fourth way points among the at least four or more way points,
determines whether the first angle and the second angle both exceed a predetermined angle, and
determines whether the UAV is to fly through all of the four way points based on whether the first angle and the second angle both exceed the predetermined angle.

13. The device of claim 1, wherein the controller:
generates control signals for controlling flight of the two or more UAVs such that the two or more UAVs perform a swarming flight; and
determines a first flight path for a first UAV among the at least two or more UAVs, and determines a second flight path that is symmetrical to the first flight path for a second UAV among the at least two or more UAVs.

14. The device of claim 1, wherein the controller determines the flight path further based on aircraft data including at least one of a location, a speed, an altitude, or an orientation for the UAV, and information obtained by one or more sensors included in the UAV such that the UAV flies at least a predetermined distance away from another UAV.

15. A system, comprising:
a unmanned aerial vehicle (UAV); and
a device to control the UAV,
wherein the UAV transmits image data recorded while flying and aircraft data including at least one of a location, a speed, an altitude, or an orientation for the UAV to the device, and
wherein the device:
determines a flight path for the UAV based on at least one of the image data or the aircraft data;
transmits a control signal to the UAV that causes the UAV to fly along the flight path;
performs machine-learning of topography information including at least one of the image data from the UAV, an electronic map, or a satellite photo to determine whether an obstacle is present on the flight path; and
configures a detour corridor based on the machine learning such that the UAV avoids the obstacle.

16. The system of claim 15, wherein the device calculates a variation in azimuth indicating a flight direction of the UAV at at least one way point along the flight path, and determines whether the UAV flies through the at least one way point based on the variation in azimuth.

17. The system of claim 16, wherein the device determines whether the UAV can fly through at least three sequential way points depending on whether an angle formed by the at least three way points exceeds a predetermined value, and determines whether a landmark is present in an area near the at least three way points based on performing the machine-learning.

18. The system of claim 17, wherein the device:
upon determining that the angle formed by the at least three way points is less than the predetermined value and that the landmark is not present at the area near the at least three way points, determines the flight path such that the UAV flies by a second way point among the at least three or more way points; and
upon determining that the angle formed by the at least three way points is less than the predetermined value and that the landmark is present at the area near the at least three way points, configures the flight path such that the UAV flies over the second way point among.

19. The system of claim 17, wherein the device:
upon determining that the angle formed by the at least three way points is not less than the predetermined value and that the landmark is not present in the area near the at least three way points, configures the flight path such that the UAV flies by a second way point among the at least three way points; and
upon determining that the angle formed by the at least three way points is not less than the predetermined value and that the landmark is present in the area near the at least three way points, configures the flight path to such that the UAV flies over the second way point.

20. The system of claim 16, wherein the device determines the flight path such that the UAV flies at least a predetermined distance away from another UAV.

21. A method of controlling an unmanned aerial vehicle (UAV), the method comprising:
identifying a plurality of way points along a flight path of the UAV;
performing machine-learning on at least one of an electronic map, a satellite photo, or at least one image captured by the UAV;
determining, based on the machine-learning, whether an obstacle is located within a predetermined range of any of the way points;
calculating an angle formed by at least three sequential way points of the flight path; and
determining, based on the calculated angle and whether an obstacle is located within the predetermined range of any of the way points, the flight path for the UAV such that the UAV sequentially flies through or within a prescribed distance of the way points.

22. The method of claim 21, further comprising determining whether a landmark is present at or within a prescribed distance of at least one of the at least three way points.

23. The method of claim 22, wherein determining the flight path includes:
upon determining that the angle formed by the at least three way points is equal to or less than a predetermined value and that the landmark is not present at or within the prescribed distance of at least one of the at least three way points, determining the flight path such that the UAV flies by a second way point among the at least three or more way points; and
upon determining that the angle formed by the at least three way points is equal to or less than the predetermined value and that the landmark is present at or within the prescribed distance of at least one of the at least three way points, determining the flight path such that the UAV flies over the second way point among the at least three way points.

24. The method of claim 22, wherein determining the flight path includes:
upon determining that the angle formed by the at least three way points is not less than a predetermined value and that the landmark is not present at or within the prescribed distance of at least one of the at least three way points, determining the flight path such that the UAV flies by a second way point among the at least three way points; and
upon determining that the angle formed by the at least three way points is not less than the predetermined angle and that the landmark is present at or within the prescribed distance of at least one of the at least three way points, configuring the flight path such that the UAV flies over the second way point.

25. The method of claim 22, wherein determining whether the landmark is present at or located within the prescribed distance of the at least three way points includes:
performing machine-learning of additional topography information including at least one of an electronic map of a region associated with the at least three way points, a satellite photo of the region associated with the at least three way points, or at least one image captured by the UAV while flinging on the flight path; and
determining whether the landmark is present within a predetermined range from any of the at least three points based on performing the machine learning of the additional topography information.

26. The method of claim 21, wherein determining the flight path includes:
receiving sensor data from the UAV;
identifying, based on the sensor data, traffic in an area associated with the way points; and
configuring, based on the traffic, the flight path such that the UAV flies through the area while maintaining a predetermined distance away from another UAV.
